(19) United States
(12) Patent Application Publication
(10) Pub. No.: US 2009/0109450 A1
(43) Pub. Date: Apr. 30, 2009

(54) IMAGE FORMING SYSTEM AND INFORMATION PROCESSING DEVICE AND METHOD EMPLOYED IN THE SYSTEM

(75) Inventor: Yoshiyuki Shino, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Misato-shi (JP)

(21) Appl. No.: 12/258,943

(22) Filed: Oct. 27, 2008

(30) Foreign Application Priority Data
Oct. 31, 2007 (JP) 2007-284102

(51) Int. Cl. G06K 15/10

(52) U.S. Cl. 358/1.8

(57) ABSTRACT

An image forming system is provided that uses printing apparatus groups each consisting of a plurality of printing apparatuses. The printing apparatuses hold print heads each provided with nozzles arrayed in a predetermined direction, are arranged two-dimensionally to cooperate with each other in printing rasters extending in the predetermined direction. Two printing apparatus groups are arranged in a medium conveying direction. In forming images in areas divided in the predetermined direction, the printing apparatuses or print heads located on the upstream side and the downstream side are appropriately set to participate in the printing of the same raster. In printing for one divided area, when only one print head is used to reduce electric power consumption or when two print heads are used for faster printing or for higher print quality, a selection is made of a combination of printing apparatuses or print heads that considers the printed image quality.

### BACKGROUND OF THE INVENTION

1. Field of the Invention

The present invention relates to an image forming system and an information processing device and method used in the system which are suitably applicable to an operation of forming images on a print medium of relatively large size.

2. Description of the Related Art

An ink jet printing system has come to find a wide range of applications for industrial, office and personal (individual and home) use, with its printing purposes increasingly diversifying. In line with these changes, a variety of print media are also being used. Particularly in the industrial field, the print medium size ranges widely, from relatively small ones, such as labels attached to products and their packages, to relatively large ones more than A2 size. The printing apparatus for industrial use also must meet far more stringent requirements than the personal use printing apparatus in terms of high-speed printing and operation stability.

Unlike a so-called serial type printer, a line type printer, which uses a print head having a large number of ink ejection openings arrayed in a direction perpendicular to a print medium conveying direction (subscan direction), is able to form an image at high speed. Because of this advantage, the line printer type ink jet printing apparatus is drawing attention as a printing apparatus suitable for industrial applications.

In the industrial field, however, various sizes of print media are used as described above, and at times it is required to print on print media of A2 size or more. In the case of a print head used in the line printer, processing the print head to form an extremely large number of nozzles without any defects over the entire width of a print area is difficult (ink ejection openings, liquid paths communicating with the openings, and devices or elements installed in the liquid paths to generate energy for ink ejection may generally be called nozzles unless otherwise specifically stated).

A conventional practice to deal with these requirements involves arranging in line a plurality of relatively inexpensive, short print head chips with high precision to elongate an ink jet print head of a line printer so that it has a required length. By arranging an appropriate number of print head chips as described above, it is possible to cope with various sizes of print media. However, an actual printing apparatus is constructed to conform to the purpose of use on the part of the user. It is therefore difficult to design various line printers swiftly and flexibly according diversified needs of individual users and provide inexpensive printers.

It can be explained as follows. In arranging in line an appropriate number of print head chips to elongate the print head to a desired length, corresponding changes must also be made of hardware and software of an associated control system. Not only does the printing apparatus require changes in the construction as described above, but an information processing device as a host device also requires significant specification changes with respect to development and transfer of image data.

Therefore, an image forming system that, while meeting the demand for faster printing speed, can also cope with a requirement for changing the size of a print medium, particularly to a large-size, quickly and easily has been proposed (WO 2004/106068). In this document is described a construction in which a plurality of printing apparatuses or printer units independent of one another (separated from one another) spatially and also in a signal system are arranged in an appropriate layout so that a printing can be performed in a line (raster) sequential order. This document also describes that the information processing device divides generated image into a plurality of pieces of print data and transfers them to the printing apparatuses and that a medium conveying device, installed to move a large-size print medium to an area where the plurality of printing apparatuses are arranged, transfers to the plurality of printing apparatuses signals that determine print timing according to the positions of the printing apparatuses.

### SUMMARY OF THE INVENTION

It is therefore an object of the present invention to further utilize the advantageous aspects of the construction disclosed in the above WO 2004/106068 and to enable a high-quality image forming while at the same time meeting a variety of demands of the user, such as faster printing speed and improved power conservation.

In a first aspect of the present invention, there is provided an image forming system having a printing apparatus group consisting of a plurality of printing apparatuses, wherein the printing apparatuses have print heads, each provided with nozzles arrayed in a predetermined direction, wherein the printing apparatuses are arranged spread in the predetermined direction and in a print medium conveying direction to cooperate with one another to print rasters extending in the predetermined direction, the image forming system comprising:

at least two of the printing apparatus groups arranged in the print medium conveying direction; and

an information processing device to generate divided image data by dividing image data into pieces corresponding to positions in the predetermined direction and the print medium conveying direction of the printing apparatuses in the at least two printing apparatus groups and to transfer the generated divided image data to the associated printing apparatuses;

wherein the information processing device can make a first setting and a second setting;

wherein the first setting is used to generate the divided image data to cause the plurality of printing apparatuses included in the same printing apparatus group to cooperate with each other in printing the same raster; and

wherein the second setting is used to generate the divided image data to cause the printing apparatuses included in one of the printing apparatus groups to cooperate with the printing apparatuses included in another printing apparatus group in printing the same raster, the other printing apparatus group differing in position in the predetermined direction from the first group.

In a second aspect of the present invention, there is provided an image forming system using a plurality of printing apparatuses, wherein the printing apparatuses are arranged spread in a predetermined direction and in a print medium conveying direction to cooperate with one another to print rasters extending in the predetermined direction, wherein each of the printing apparatuses is provided with at least two print heads corresponding to the same color tone, the print head having nozzles arrayed in the predetermined direction, the image forming system comprising:

an information processing device to generate divided image data by diving image data into pieces corresponding to positions of the printing apparatuses in the predetermined direction and to positions in the print medium conveying direction of the at least two print heads and to transfer the generated divided image data to the associated printing apparatuses;

wherein the information processing device can make a first setting and a second setting;

wherein the first setting is used to generate the divided image data to cause those print heads in the plurality of printing apparatuses that are located at matching positions in the medium conveying direction to cooperate with each other in printing the same raster; and

wherein the second setting is used to generate the divided image data to cause those print heads in the plurality of printing apparatuses that are located at unmatching positions in the medium conveying direction to cooperate with each other in printing the same raster.

In a third aspect of the present invention, there is provided an information processing device to be employed in an image forming system according to the first aspect, to generate divided image data by dividing image data into pieces corresponding to positions in the predetermined direction and the print medium conveying direction of the printing apparatuses in the at least two printing apparatus groups and to transfer the generated divided image data to the associated printing apparatuses;

wherein the information processing device can make a first setting and a second setting;

wherein the first setting is used to generate the divided image data to cause the plurality of printing apparatuses included in the same printing apparatus group to cooperate with each other in printing the same raster; and

wherein the second setting is used to generate the divided image data to cause the printing apparatuses included in one of the printing apparatus groups to cooperate with the printing apparatuses included in another printing apparatus group in printing the same raster, the other printing apparatus group differing in position in the predetermined direction from the first group.

In a fourth aspect of the present invention, there is provided an information processing device to be employed in an image forming system according to the second aspect, to generate divided image data by diving image data into pieces corresponding to positions of the printing apparatuses in the predetermined direction and to positions in the print medium conveying direction of the at least two print heads and to transfer the generated divided image data to the associated printing apparatuses;

wherein the information processing device can make a first setting and a second setting;

wherein the first setting is used to generate the divided image data to cause those print heads in the plurality of printing apparatuses that are located at matching positions in the medium conveying direction to cooperate with each other in printing the same raster; and

wherein the second setting is used to generate the divided image data to cause those print heads in the plurality of printing apparatuses that are located at unmatching positions in the medium conveying direction to cooperate with each other in printing the same raster.

In a fifth aspect of the present invention, there is provided a method of information processing to be employed in an image forming system according to the first aspect, to generate divided image data by dividing image data into pieces corresponding to positions in the predetermined direction and the print medium conveying direction of the printing apparatuses in the at least two printing apparatus groups and to transfer the generated divided image data to the associated printing apparatuses;

wherein the method can make a first setting and a second setting;

wherein the first setting is used to generate the divided image data to cause the plurality of printing apparatuses included in the same printing apparatus group to cooperate with each other in printing the same raster; and

wherein the second setting is used to generate the divided image data to cause the printing apparatuses included in one of the printing apparatus groups to cooperate with the printing apparatuses included in another printing apparatus group in printing the same raster, the other printing apparatus group differing in position in the predetermined direction from the first group.

In a sixth aspect of the present invention, there is provided a method of information processing to be employed in an image forming system according to the second aspect, to generate divided image data by diving image data into pieces corresponding to positions of the printing apparatuses in the predetermined direction and to positions in the print medium conveying direction of the at least two print heads and to transfer the generated divided image data to the associated printing apparatuses;

wherein the method can make a first setting and a second setting;

wherein the first setting is used to generate the divided image data to cause those print heads in the plurality of printing apparatuses that are located at matching positions in the medium conveying direction to cooperate with each other in printing the same raster; and

wherein the second setting is used to generate the divided image data to cause those print heads in the plurality of printing apparatuses that are located at unmatching positions in the medium conveying direction to cooperate with each other in printing the same raster.

In a seventh aspect of the present invention, there is provided a control program for making a computer execute a method of information processing according to the fifth or sixth aspect.

In an eighth aspect of the present invention, there is provided a storage medium storing a control program for making a computer execute a method of information processing according to the fifth or sixth aspect.

In an operation of forming an image in each of areas divided in a predetermined direction (in a direction of width of a print medium), this invention can properly set printing apparatuses or print heads located upstream in a medium conveying direction and printing apparatuses or print heads located downstream so that both of them are involved in the printing of the same rasters. So, in the process of printing one divided area, when only one print head is used for reduced power consumption or when two print heads are used for higher printing speed or higher print quality, it is possible to select a combination of printing apparatuses or print heads according to a desired quality of printed image.

Further features of the present invention will become apparent from the following description of exemplary embodiments (with reference to the attached drawings).

### BRIEF DESCRIPTION OF THE DRAWINGS

FIG. 1 is a block diagram showing an outline of an image forming system according to a first embodiment of this invention;

FIG. 2 is a schematic top view of a printer complex system in the image forming system of FIG. 1;

FIG. 3 is a schematic perspective view showing a part of a printer complex system (upstream side printing apparatuses) in the image forming system of FIG. 1;

FIG. 4 illustrates an example setting screen that determines which part of a 1-page image is to be printed by which of the printing apparatuses connected to the information processing device;

FIG. 5 is a flow chart showing an example operation sequence of the information processing device that is initiated when a printer driver requests an execution of printing;

FIG. 6 is a block diagram showing an example configuration of a control system in a printing apparatus according to the first embodiment of this invention;

FIG. 7 is a block diagram showing an example configuration of a control system in a medium conveying device according to the first embodiment of this invention;

FIG. 8 is a block diagram showing an example configuration of a signal system for a plurality of printing apparatuses making up the printer complex system;

FIG. 9 is a flow chart showing an interrelated operation sequence among the information processing device, the printing apparatuses of the printer complex system and the medium conveying device in the image forming system;

FIG. 10 is a schematic enlarged view of a printed image at a boundary portion between two adjoining areas being printed by the printing apparatuses arranged as shown in FIG. 2;

FIG. 11 is a schematic enlarged view of a printed image at a boundary portion between two adjoining areas being printed by the printing apparatuses when an ejection failure occurs with an end nozzle of one of the print heads installed in the printing apparatuses;

FIG. 12 is a schematic enlarged view of a printed image at a boundary portion between two adjoining areas being printed by the printing apparatuses when an ejection volume change occurs with one of the print heads installed in the printing apparatuses;

FIG. 13 is a schematic enlarged view of a printed image at a boundary portion between two adjoining areas being printed by the printing apparatuses when an ejection deflection occurs with nozzles of one of the print heads installed in the printing apparatuses;

FIG. 14A and FIG. 14B show dot landing positions in one raster and nozzle drive timings to form the dots when only the upstream side printing apparatuses of FIG. 2 are used for printing;

FIGS. 15A-15E explain how density unevenness is produced by a time difference in ink ejection timing;

FIG. 16A and FIG. 16B show dot landing positions in one raster and nozzle drive timings to form the dots when a modified operation of the first embodiment of this invention is applied;

FIG. 17 shows how an image degradation occurs at a boundary portion between two adjoining areas when an ejection failure occurs with end nozzles of two print heads cooperating to print one raster;

FIG. 18 schematically show the image degradation of FIG. 17 being alleviated when a modified operation of the first embodiment of this invention is applied;

FIG. 19 shows an example setting screen used to apply a modified operation of the first embodiment of this invention;

FIG. 20 is a schematic top view of a printer complex system in an image forming system according to a second embodiment of this invention;

FIG. 21 is a schematic enlarged view of a printed image at a boundary portion between two adjoining areas being printed by the printing apparatuses arranged as shown in FIG. 20;

FIG. 22 is a schematic enlarged view of a printed image at a boundary portion between two adjoining areas being printed by the printing apparatuses arranged as shown in FIG. 2;

FIG. 23 is a schematic top view of a printer complex system in an image forming system according to a third embodiment of this invention;

FIG. 24 is a schematic enlarged view showing a part of FIG. 23 to explain an overlapping arrangement of nozzles;

FIG. 25 is an explanatory diagram showing how stripe-like unevenness occurring between adjoining areas are alleviated by the third embodiment; and

FIG. 26 is a schematic top view of a printer complex system in an image forming system according to a variation of the third embodiment of this invention.

### DESCRIPTION OF THE EMBODIMENTS

Now, the present invention will be described in detail by referring to the accompanying drawings.

Incidentally, in this Specification, the word “print” (also referred to as “image forming”) represents not only forming of significant information, such as characters, graphic image or the like but also represent to form image, patterns and the like on the print medium irrespective whether it is significant or not and whether the formed image elicited to be visually perceptible or not, in broad sense, and further includes the case where the medium is processed.

The word “print medium” represents not only paper to typically used in the printing apparatus but also cloth, plastic film, metal plate, glass, ceramics, wood and leather and the like and any substance which can accept the ink in broad sense.

The word “ink” (also referred to as “liquid”) should be interpreted in a broad sense as well as a definition of the above “printing” and thus the ink, by being applied on the printing media, shall mean a liquid to be used for forming images, designs, patterns and the like, processing the print medium or processing inks (for example, coagulation or encapsulation of coloring materials in the inks to be applied to the printing media).

Further, an ink ejection opening, a liquid path communicating with the opening, and a device or element installed in the liquid path to generate energy for ink ejection may generally be called a “nozzle” unless otherwise specifically stated.

### 1. First Embodiment

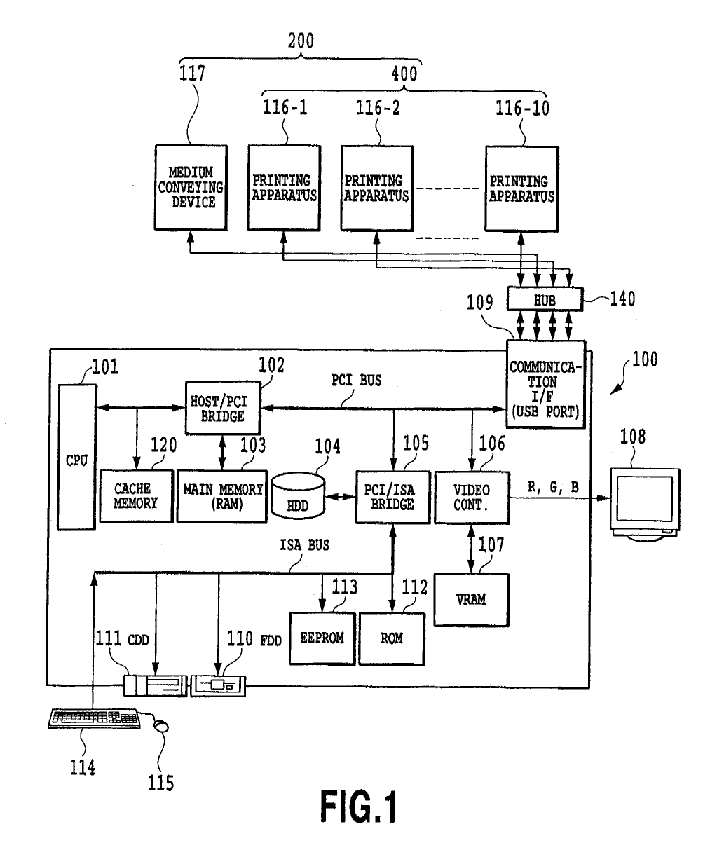

1-1 Outline Configuration of Image Forming System (FIG. 1 to FIG. 3)

FIG. 1 is a block diagram showing an outline of the image forming system according to the first embodiment of this invention. The image forming system of this embodiment generally comprises an information processing device 100 and an image forming apparatus 200. The image forming apparatus 200 has a medium conveying device 117 and a printer complex system 400, the latter being made up of a plurality of independent engines or printing apparatuses 116-1 to 116-10.

Here, the information processing device 100 is a source of image data to be formed. It divides one page of image into a plurality of sections in a direction of print medium width and in a conveying direction of print medium and supplies the divided image data to a plurality of printing apparatuses 116-1 to 116-10 making up the printer complex system 400. The medium conveying device 117 conveys a print medium 206, whose width corresponds to a range of area that can be printed by an array of printing apparatuses 116-1 to 116-10. The medium conveying device 117 also detects a front end of the medium and outputs to the printing apparatuses 116-1 to 116-10 signals defining their print start positions.

The printer complex system 400 has a plurality (in this example, 10) of printing apparatuses 116-1 to 116-10 so arranged as to print corresponding divided areas of a print medium 206. Each of the printing apparatuses, based on the divided image data supplied from the information processing device 100, executes the printing operation on the assigned print area at a timing defined by the medium conveying device 117. Each of the printing apparatuses are provided with print heads 811Y, 811C, 811M, 811K to eject yellow (Y), magenta (M), cyan (C) and black (K) inks, respectively, onto the print medium 206 for full color printing. These print heads are supplied the associated color inks from ink sources or ink tanks 203Y, 203M, 203C, 203K, respectively.

1-2 Information Processing Device (FIG. 1)

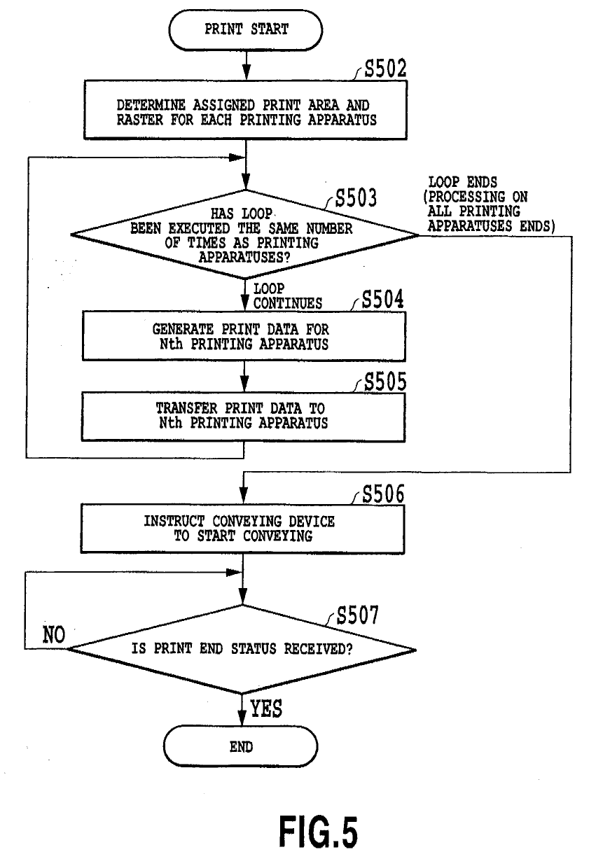

In FIG. 1, CPU 101 is a central processing unit in charge of an overall system control of the information processing device 100. In the information processing device 100, CPU 101 under the control of an operating system (OS) executes processing defined by application programs for generating and editing image data, image dividing program of this embodiment (described later referring to FIG. 5), a control program (printer driver) for the printing apparatuses 116-1 to 116-10 and programs corresponding to the procedure of FIG. 5.

A system bus of the CPU 101 is hierarchically structured. More specifically, the CPU is connected through a host/PCI bridge 102 to a local bus, such as PCI bus, and further connected through a PCI/ISA bridge 105 to an ISA bus for connection with devices on these buses.

A main memory 103 is a RAM in which is provided a temporary storage area for OS, application programs and the control program. It is also used as a work area for executing the programs. These programs are read from, for example, a hard disk drive HDD 104 and loaded. The system bus has a high-speed memory called a cache memory 120 using a SRAM (Static RAM), in which are stored codes and data frequently accessed by the main CPU 101.

The ROM 112 stores a program (BIOS: Basic Input Output System) that controls input/output devices, such as keyboard 114, mouse 115, CDD 111 and FDD 110, connected through an input/output circuit (not shown); an initialization program that is activated when a system is powered on; a self-diagnostic program; and others. The EEPROM (Electronic Erasable and Programmable ROM) 113 is a nonvolatile memory to store various permanently usable parameters.

The video controller 106 continuously and cyclically reads RGB display data written into a VRAM (Video RAM) 107 and continuously transfers them as display refreshing signals to a display 108 such as CRT, LCD and PDP (Plasma Display Panel).

The communication interface 109 for the printing apparatuses 116-1 to 116-10 is connected to the PCI bus and may use, for example, bidirectional Centronics interface compatible with IEEE 1284 standard, USB (Universal Serial Bus) and Ethernet (trademark). FIG. 1 shows a configuration in which the communication interface 109 is connected with a hub 140, which is further connected to the printing apparatuses 116-1 to 116-10 and the medium conveying device 117. While this embodiment is shown to use the wired type communication interface 109, a wireless type may also be used.

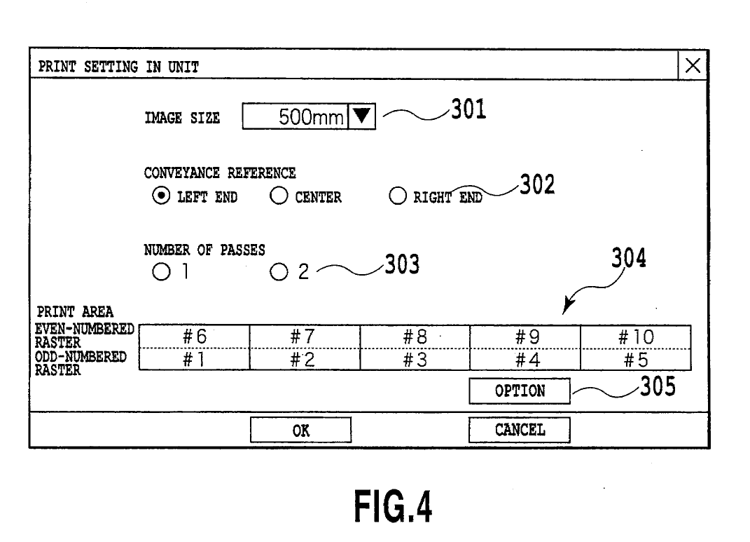

The print program (printer driver) has a unit for setting areas that are assigned to the plurality of printing apparatuses 116-1 to 116-10 connected to the information processing device 100 (described later with reference to FIG. 4). Based on the settings made by this unit, the print program divides one page of image, transfers the divided image data to the associated printing apparatuses 116-1 to 116-10, and instructs them to print the image data.

As described above, since the print program generates print data for the plurality of printing apparatuses 116-1 to 116-10 and transfers the print data to the individual printing apparatuses, the print program itself or the print data generation processing and the print data transfer processing in the program are executed parallelly (multiprocess, multithread), completing the required processing quickly.

1-3 Printer Complex System (FIG. 1 to FIG. 4)

As shown in FIG. 1, the information processing device 100 is connected to the plurality of printing apparatuses 116-1 to 116-10 and the medium conveying device 117 through the hub 140 to transfer print data and operation start and end commands. The individual printing apparatuses 116-1 to 116-10 (generally referenced by numeral 116 when no particular printing apparatus is specified) are also connected with the medium conveying device 117 so that signals representing the detection of the front end of the print medium 206 and the setting of the print start position and signals for synchronizing the medium conveying speed with the printing operation (ink ejection operation) of the individual printing apparatuses are transferred between the printing apparatuses and the medium conveying device.

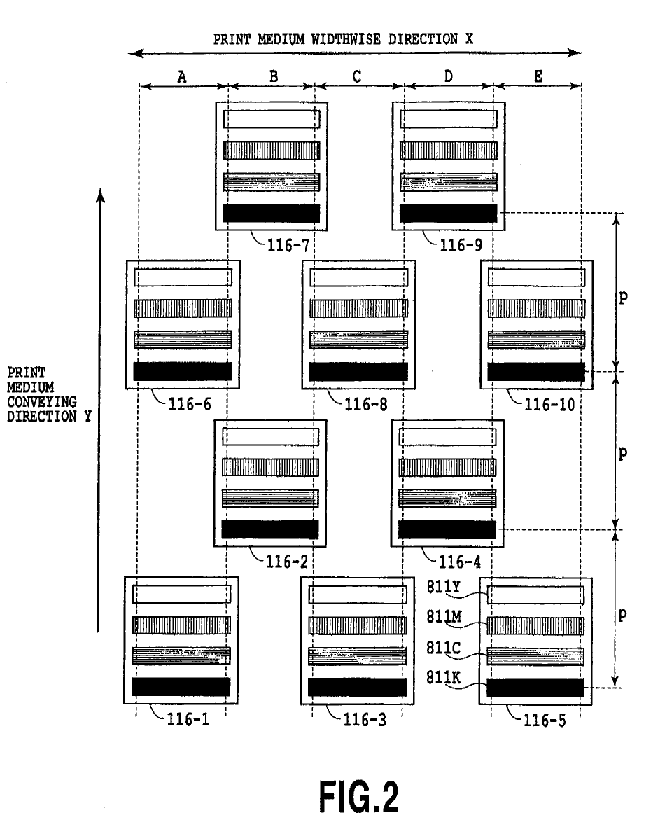

Each of the printing apparatuses 116, as shown in FIG. 2, has four print heads 811Y, 811M, 811C, 811K (generally referenced by numeral 811 when no particular print head is specified) for ejecting yellow (Y), magenta (M), cyan (C) and black (K) inks, respectively, for continuous full-color printing on the print medium 206. The order of arrangement of the print heads in the medium conveying direction is the same for all printing apparatuses and therefore the order of color overlapping is also the same. Ink ejection openings in each print head are arrayed in a widthwise direction of the print medium (perpendicular to the medium conveying direction) at intervals of 600 dpi (dots/inch) over four inches (about 100 mm).

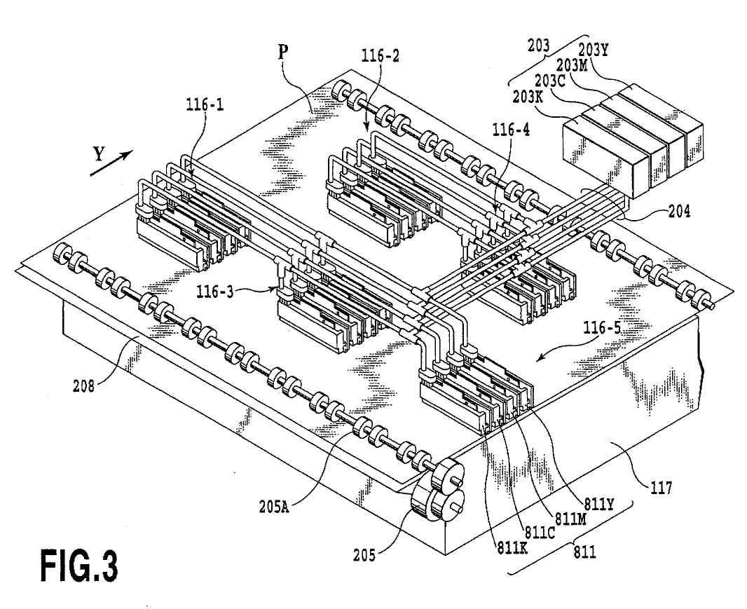

In this embodiment, as shown in FIG. 3, the printing apparatuses 116-1 to 116-5 are arranged to cover a maximum overall print width of about 500 mm. Similarly, the printing apparatuses 116-6 to 116-10 are also arranged to cover a maximum overall print width of about 500 mm. The printing apparatuses 116-1 to 116-5 and the printing apparatuses 116-6 to 116-10 are located on an upstream side and a downstream side in the medium conveying direction Y (they are also referred to as an upstream side printing apparatus group and a downstream side printing apparatus group). Thus, a pair of printing apparatuses 116-1 and 116-6, a pair of printing apparatuses 116-2 and 116-7, a pair of printing apparatuses 116-3 and 116-8, a pair of printing apparatuses 116-4 and 116-9 and a pair of printing apparatuses 116-5 and 116-10 can cover the same print areas A, B, C, D and E (100 mm wide), respectively, in a direction of the print medium width X. In each of these printing apparatus pairs, the corresponding print heads can also be assigned different parts of a print area that are divided in the medium conveying direction Y (e.g., different rasters in the print area).

FIG. 4 shows an example setting screen on the display unit 108 that determines which parts of a 1-page image the printing apparatuses 116-1 to 116-10 connected to the information processing device 100 will cover (print area assignment setting). The display of this setting screen is controlled by the CPU 101 executing the print program (printer driver).

In a setting field 301 on the screen of the display unit 108, one can determine an image size to be printed. In this example, printing apparatuses each with a printable width of 100 mm are arranged as shown in FIG. 2 and FIG. 3, so it is possible to print an image measuring 500 mm in width and any desired size in length (in the medium conveying direction). A setting field 302 allows the user to determine the position of a print medium conveyance reference in the X direction. A setting field 303 allows one to choose between using one of the upstream and downstream side printing apparatuses in printing the assigned area and using both. That is, the user can determine whether to perform a 1-pass printing to print all rasters of image data with only one of the upstream and downstream side printing apparatuses or a 2-pass printing to print alternate rasters of image data with both of the printing apparatuses.

In this embodiment, the five 100-mm-wide areas A-E, beginning with the left end in FIG. 2, are printed by the five pairs of printing apparatuses 116, with the print area A printed by the pair of printing apparatuses 116-1 and 116-6, the print area B by the pair of printing apparatuses 116-2 and 116-7, the print area C by the pair of printing apparatuses 116-3 and 116-8, the print area D by the pair of printing apparatuses 116-4 and 116-9 and the print area E by the pair of printing apparatuses 116-5 and 116-10. Thus, which print area is printed by which pair of printing apparatuses is uniquely determined by the physical arrangement of the printing apparatuses (see FIG. 2). In the example of FIG. 4, the image size (width) is selected at “500 mm”, the conveyance reference is set at a “left end”, and a 2-pass printing is selected. Therefore, in the assignment setting field 304 the printing apparatuses 116-1 to 116-10 (#1 to #10) are shown at positions corresponding to their assigned print areas in the X direction and to their associated rasters in the Y direction. When instructed to start printing, the printing apparatuses print the associated rasters in their assigned print areas, cooperating together to form one image.

Denoted 305 is a setting field to change the combinations of printing apparatuses (combinations of #1-#5 and combinations of #6-#10) used to print individual rasters. This will be described later.

Although in the example of FIG. 4 the print area assignment setting has been described to be made on the screen of the display unit 108, it may be set using registry information held by OS or system preference setting file.

Further, in this example the printing apparatuses 116-1 to 116-5 and printing apparatuses 116-6 to 116-10 are arranged to cover print areas not overlapping in the Y direction. However, to prevent small portions between adjoining print areas from being left unprinted or blank due to degraded arrangement precision, the printing apparatuses covering the adjoining areas may be arranged to overlap each other at their boundary portion. This will be detailed later.

FIG. 5 is a flow chart showing an example sequence of steps initiated when the printer driver instructs a printing operation.

When this sequence is started by the CPU 101, the program, based on the setting information specified on the setting screen of FIG. 4, determines the print area and rasters to be printed by each of the printing apparatuses 116-1 to 116-10 (step S502).

Next, the following operations are repeated the same number of times as the number of printing apparatuses to be used in the printing operation (step S503). That is, the operations to be repeated include one that generates divided image data for each of the printing apparatuses 116-1 to 116-10, based on information indicating which area and rasters in the 1-page image need to be printed (step S504), and one that transfers the generated data from the communication interface 109 (step S505). By repeating these operations the number of times equal to the number of printing apparatuses used for printing, the divided image data for the individual printing apparatuses 116-1 to 116-10 is generated by and transferred from the information processing device 100.

Then the medium conveying device 117 is started (step S506). When a required printing operation is finished and an end status is received from the medium conveying device 117 or the printing apparatuses 116-1 to 116-10 (step S507), the program ends this procedure.

Although in the sequence of FIG. 5 the print data generation and transfer operations have been described to be performed sequentially for the printing apparatuses 116-1 to 116-10, they may be executed parallelly.

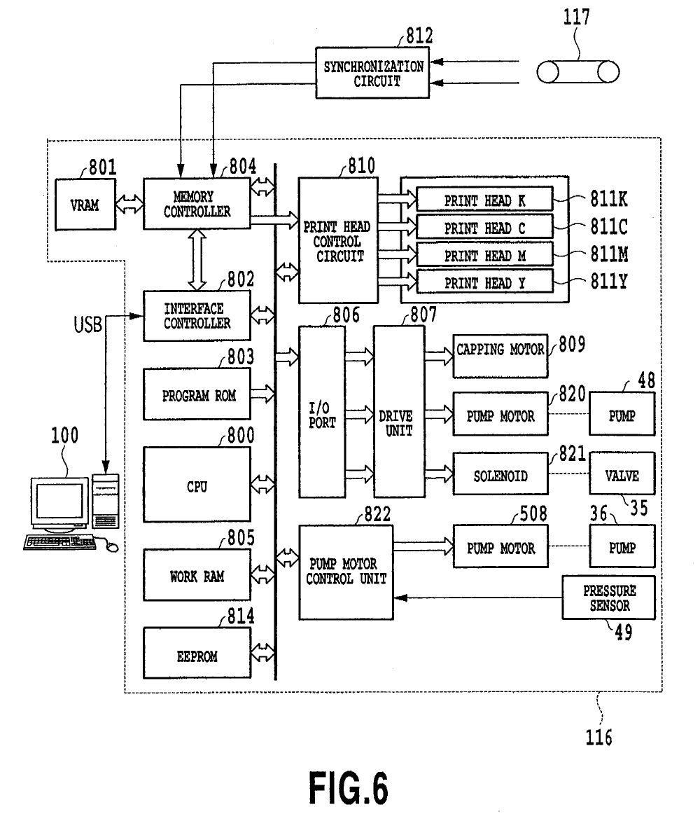

1-4 Printing Apparatus (FIG. 6)

FIG. 6 shows an example configuration of a control system in each printing apparatus 116 according to this embodiment.

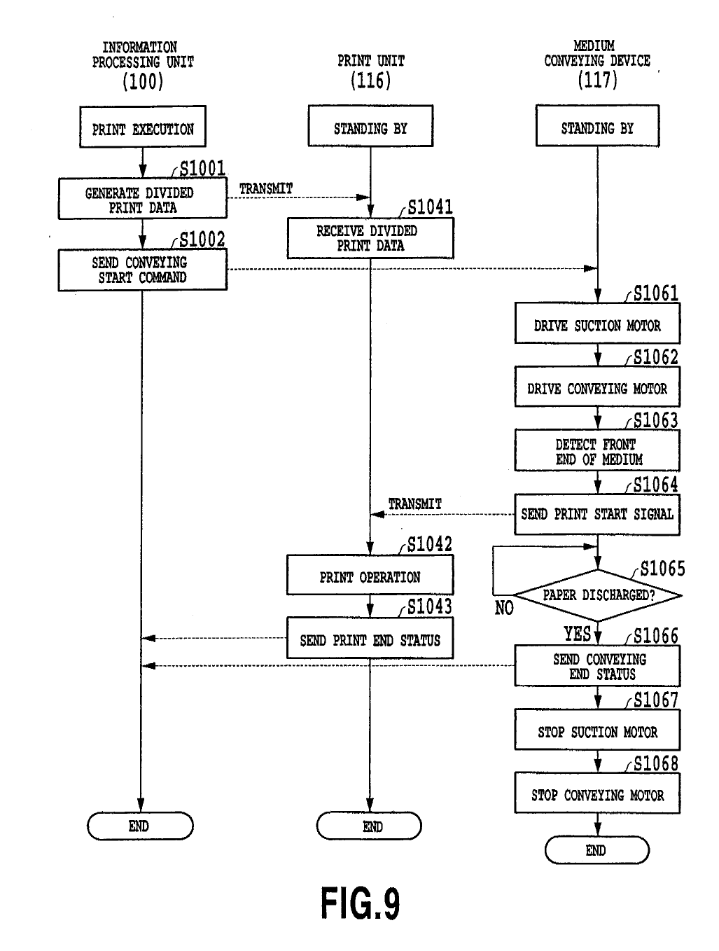

In the figure, denoted 800 is a CPU that performs an overall control of the printing apparatus 116 according to a program corresponding to the steps of FIG. 9; 803 a ROM storing the program and fixed data; 805 a RAM used as a work area; and 814 a nonvolatile EEPROM storing parameters unique to each printing apparatus.

Designated 802 is an interface controller to connect the printing apparatus to the information processing device 100 via a USB cable. Denoted 801 is a VRAM in which to arrange print data for each print head or color. A memory controller 804 transfers to the VRAM 801 the divided image data received by the interface controller 802 (data that is generated by step S504 of FIG. 5 and transmitted over from the information processing device 100 by step S505). The memory controller also performs control to read print data to be printed by the individual print heads as the printing operation proceeds. When the divided image data, which is divided among assigned areas in the X direction and among assigned rasters in the Y direction, is received by the interface controller 802 from the information processing device 100 via a USB cable, the CPU 800 analyzes a command attached to the divided image data and issues an instruction for bit-mapping the image data of each color component (print data for each color print head) in the VRAM 801. Upon receiving this instruction, the memory controller 804 writes the image data from the interface controller 802 into the VRAM 801 at high speed and then develops a bit-map of print data for each color print head.

Denoted 810 is a control circuit to control color print heads 811Y, 811M, 811C, 811K. A capping motor 809 is a drive source for a capping mechanism (not shown) that caps a face of the print head 811 formed with ejection openings. Denoted 808 is an operation unit including pumps and valves of an ink system (including an ink supply system and a recovery system) described later. Denoted 807 is a drive unit to drive the ink system operation unit 808 and the capping motor 809. When the printing apparatus 116 is not used, the capping motor 809 is activated to move the capping mechanism relative to the print heads 811Y, 811M, 811C, 811K to cap them. When image data to be printed is developed in the VRAM 801, a print head up/down motor not shown and the capping motor 809 are driven to uncap the print heads and the printing apparatus waits for a print start signal from the medium conveying device 117, which is described later.

Denoted 806 is an input/output (I/O) port 806. The drive unit 807 is connected with motors, operation unit and sensors (not shown) and transfers signals to and from the CPU 800. Denoted 812 is a synchronization circuit which receives from the medium conveying device 117 a print medium head signal and a position pulse signal, that is in synchronism with the movement of the medium, and generates a timing signal to execute the printing operation in synchronism with these signals. That is, in synchronism with the position pulse signal produced as the print medium is conveyed, data in the VRAM 801 is read out at high speed by the memory controller 804 which then delivers it through the control circuit 810 to the print heads 811 for color printing.

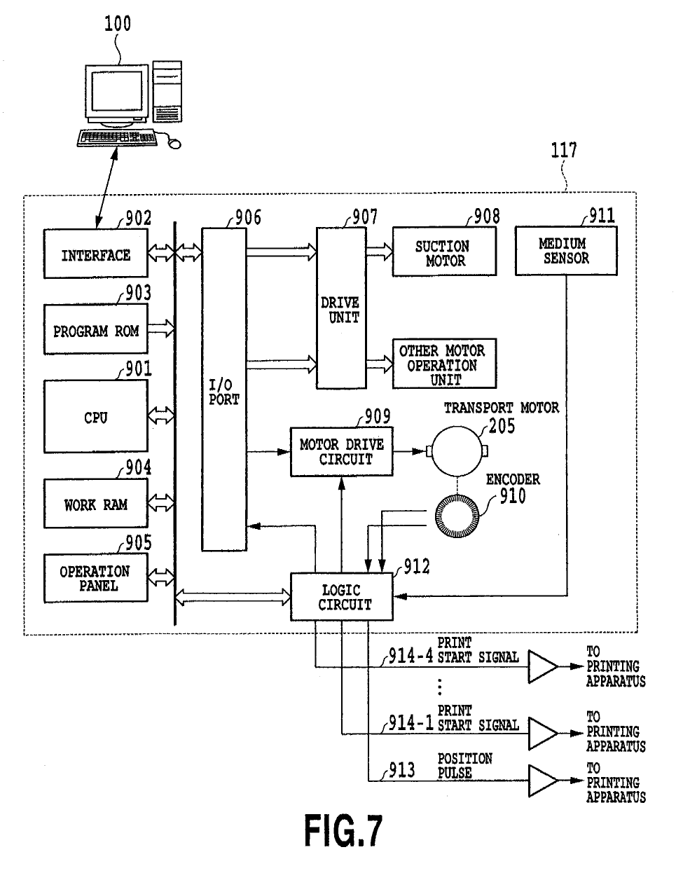

1-5 Medium Conveying Device (FIG. 7)

The medium conveying device 117 of FIG. 3 is suited for conveying a print medium which is large in the widthwise direction and has an arbitrary size in the conveying direction. At a position facing the print heads 811 of the printing apparatuses 116-1 to 116-5 of the upstream side printing apparatus group, a media stage 202 for holding flat a print surface of the print medium 206 is installed. The similar configuration is also provided for the printing apparatuses 116-6 to 116-10 of the downstream side printing apparatus group not shown in FIG. 3. Since print media used have various thicknesses, a unit may be added to improve the level of intimate contact between the print medium and the media stage 202 so that the print surface of even a thick medium can be kept flat. A conveying motor 205 drives a conveying roller train 205A to convey the print medium in contact with the upper surface of the media stage 202.

FIG. 7 shows an example configuration of a control system for the medium conveying device 117 according to this embodiment.

In the figure, denoted 901 is a CPU that performs an overall control on the medium conveying device according to a program governing a procedure described later with reference to FIG. 9. Denoted 903 is a ROM that stores the program and fixed data. A RAM 904 is used as a work memory area.

Designated 902 is an interface that connects the medium conveying device 117 to the information processing device 100. An operation panel 905 has an input unit for the user to enter various data and commands to the image forming apparatus and a display unit for visual display. In this example, it is provided in the medium conveying device.

Denoted 908 is a suction motor which, as an example of a unit for improving the level of intimate contact between the print medium and the media stage 202, drives a vacuum pump to perform suction from below the media stage 202 through many fine holes formed in a conveying surface of the media stage 202 to keep the print medium in intimate contact with the stage. Then, when a conveying start command is received from the information processing device 100 through the interface 902, the CPU 901 first starts the suction motor 908 to draw the print medium 206 to the upper surface of the media stage 202 by suction.

Denoted 907 is a drive unit to drive the suction motor 908 and other operation units. Denoted 909 is a drive unit for the conveying motor 205.

Designated 912 is a logic circuit that constitutes a servo system to perform a feedback control on the conveying motor 205 to convey the print medium at a constant speed by receiving an output from a rotary encoder 910 mounted on a shaft of the conveying motor 205. Here, the conveying speed can be set at any desired speed by the CPU 901 writing a target speed value into the logic circuit 912. The rotary encoder 910 may be arranged coaxial with the conveying roller train 205A, rather than being mounted on the conveying motor 205. It may also be added later, instead of being incorporated into the medium conveying device 117 from the beginning.

Also entered into the logic circuit 912 is an output of a medium sensor 911 provided upstream of the print position in the conveying direction to detect that the front end of the print medium 206 has come near the print start position (the medium sensor 911 may also be added later, rather than being incorporated into the medium conveying device 117 from the beginning). Then, the logic circuit 912 outputs an appropriate print command signal to each printing apparatus according to the distance from the position where the front end of the print medium is detected by the medium sensor 911 to the respective printing apparatuses.

In this embodiment, as shown in FIG. 3, the printing apparatuses 116-1 to 116-5 of the upstream side printing apparatus group are arranged in two rows in the conveying direction. That is, the printing apparatuses 116-1, 116-3 and 116-5 are arranged at the same position in the conveying direction. At a predetermined distance from these printing apparatuses in the conveying direction, the printing apparatuses 116-2 and 116-4 are arranged at the same position in the conveying direction. The same arrangement is also made for the downstream side group of the printing apparatuses 116-6 to 116-10, with the printing apparatuses 116-6, 116-8 and 116-10 set at the same position in the conveying direction and with the printing apparatuses 116-7 and 116-9 set at the same position in the conveying direction. Therefore, the logic circuit 912 outputs four print start signals 914-1 to 914-4. Considering errors in the mounting positions of the printing apparatuses, it is possible to make corrections on the print start signals 914-1 to 914-4 for each printing apparatus independently.

The logic circuit 912 appropriately converts an output of the rotary encoder 910 to produce a print medium position pulse signal 913, and the individual printing apparatuses perform the printing operation in synchronism with the position pulse signal 913. The resolution of the position pulse signal may be arbitrarily set. For example, it may be set to match an interval of a plurality of print lines.

The construction of the print medium conveying unit in the medium conveying device 117 is not limited to the one shown in FIG. 2 that has the fixed media stage 202. For example, it may have an endless conveying belt wound around a pair of drums arranged upstream and downstream of the print position in the medium conveying direction. A print medium may be carried on the conveying belt as the belt is moved by the rotation of the drums. The print medium 206 to be conveyed may be of a cut paper type or a continuous roll paper type.

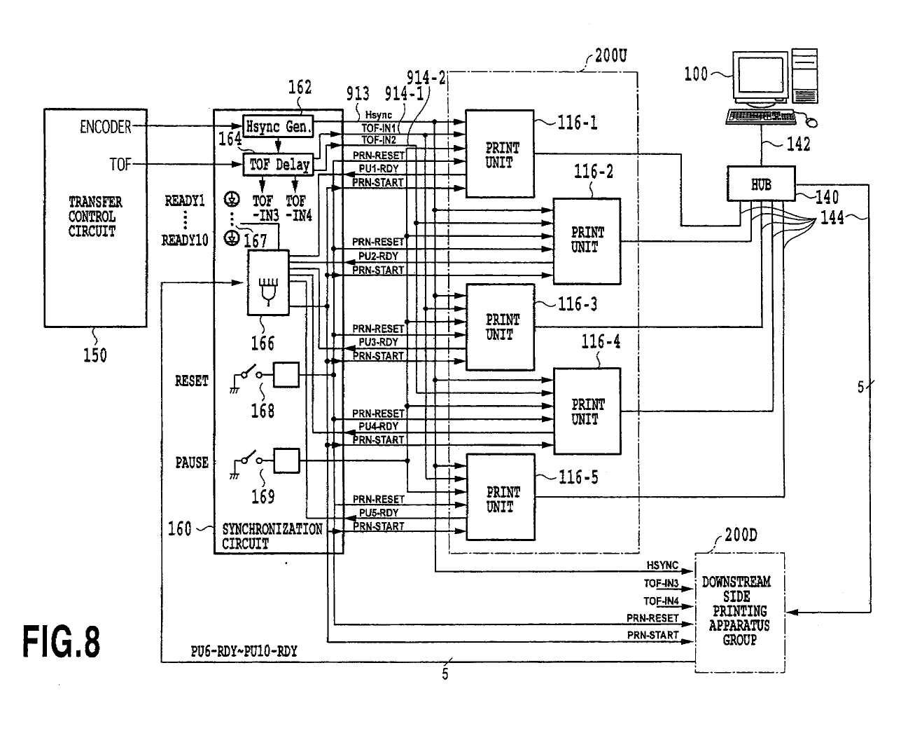

1-6 Signal System for Printer Complex System (FIG. 8)

FIG. 8 shows an example configuration for signal transfer among the information processing device 100, the medium conveying device 117 and the printing apparatuses 116-1 to 116-10 making up the printer complex system. In this figure, signal paths for the printing apparatuses 116-1 to 116-5 included in the upstream side printing apparatus group 200U are shown detailed while those for the downstream side printing apparatus group 200D are shown simplified.

There are roughly two signal systems connected to the printing apparatuses 116-1 to 116-10. One system has a function of transferring divided image data (including operation start and end commands) supplied from the information processing device 100. The other system is designed to transfer a print timing defining signal (including print start signal and position pulse) supplied from the medium conveying device 117.

In the example of FIG. 8, the first signal system has a hub 140 placed between the information processing device 100 and the printing apparatuses 116-1 to 116-10. The hub 140 is connected to the information processing device 100 through a 100 BASE-T standard connector/cable 142 and to the printing apparatuses 116-1 to 116-10 through a 10 BASE-T standard connector/cable 144.

The print timing defining signal transfer system in the example of FIG. 8 has a transfer control circuit 150 and a synchronization circuit 160. These circuits may be provided as a circuit forming the logic circuit 912. The transfer control circuit 150 supplies an output (ENCODER) of the rotary encoder 910 mounted on the shaft of the conveying motor 205 and a detection output (TOF) of the medium sensor 911, that detects the front end of the print medium, to the synchronization circuit 160.

The synchronization circuit 160 has a print operation permission circuit 166, which calculates a logical AND of operation ready signals PU1-RDY to PU10-RDY from the printing apparatuses 116-1 to 116-10 indicating that the printing apparatuses have received divided image data and which issues a print start signal PRN-START to the printing apparatuses when all the printing apparatuses are found ready to print (after uncapping the print heads). The synchronization circuit 160 is also provided with an indication unit 167, such as LEDs, displaying a state associated with the operation ready signals PU1-RDY to PU10-RDY to allow the user to visually check the operation ready state of the printing apparatuses. Further, the synchronization circuit 160 is provided with a reset unit 168 for manual forced resetting of the printing apparatuses and with a pause unit 169 for temporarily stopping the printing operation, for example, after one sheet of print medium has been printed.

The synchronization circuit 160 also has a synchronization signal generation unit 162 and a delay circuit 164. The synchronization signal generation unit 162 is designed to generate from the encoder output (ENCODER) a position pulse signal 913 (e.g., 300 pulse signals per inch of travel distance of the print medium) which corresponds to the synchronization signal (HSYNC) for synchronizing all the printing apparatuses during the printing operation. The delay circuit 164 generates from the medium front end detection output (TOF) the print start signals 914-1 to 914-4 which are delay signals corresponding to the position of the printing apparatuses in the medium conveying direction.

The print operation of the printing apparatuses 116-1, 116-3 and 116-5 located on the most upstream side in the print medium conveying direction is started when they receive a print start signal (TOF-IN1) 914-1 being a delay signal that has a delay corresponding to a distance from the medium sensor 911 to the position of each printing apparatus. If the distance from the medium sensor 911 to the position of the individual printing apparatuses is zero, the print start signal 914-1 is supplied almost simultaneously with the detection output TOF.

The print operation of the printing apparatuses 116-2 and 116-4 located on the downstream side is started when they receive a print start signal (TOF-IN2) 914-2 being a delay signal that has a delay corresponding to a distance from the medium sensor 911 to the position of each printing apparatus. Suppose, for example, the distance from the medium sensor 911 to these printing apparatuses is set at 450 mm and that the position pulse signal 913 or synchronization signal (HSYNC) has 300 pulses per inch (25.4 mm) of the movement of the print medium. Then, the print start signal 914-2 is issued 5,315 pulses after the detection output (TOF).

For the printing apparatuses 116-6, 116-8 and 116-10 located further downstream, their print operation is similarly started when they receive a print start signal (TOF-IN3) 914-3 being a delay signal that has a delay corresponding to a distance from the medium sensor 911 to the position of these printing apparatuses. Also for the printing apparatuses 116-7 and 116-9 located most downstream, their print operation is similarly started when they receive a print start signal (TOF-IN4) 914-4 being a delay signal that has a delay corresponding to a distance from the medium sensor 911 to the position of these printing apparatuses.

The arrangement pitches in the conveying direction of the printing apparatuses 116-1, 116-3, 116-5, the printing apparatuses 116-2, 116-4, the printing apparatuses 116-6, 116-8, 116-10 and the printing apparatuses 116-7, 116-9 can be set at any desired value. In this embodiment, however, the arrangement pitches of these printing apparatus groups are set equal.

To allow for making minute corrections on the print positions in the medium conveying direction of individual printing apparatuses or considering a case where the printing apparatuses are not arranged in four rows, the print start signal may be supplied independently to the individual printing apparatuses.

In each printing apparatus 116, the print heads 811K-811Y are located at different positions in the conveying direction (Y direction). So, upon reception of the print start signal, the print heads are driven according to their positions.

As can be seen from FIG. 8, each of the printing apparatuses 116-1 to 116-10 receives divided print data from the information processing device 100 and independently performs the print operation according to the print timing defining signal supplied from the medium conveying device 117. More specifically, each of the printing apparatuses 116-1 to 116-10 forms a complete unit in terms of the signal system, rather than a configuration in which the print data and print timing are transmitted through one printing apparatus to another. Each printing apparatus is provided with units (such as a shift register and a latch circuit) to arrange data for nozzles arrayed in each of the print heads 811Y-811K and perform ink ejection operations at specified timings. In other words, the printing apparatuses 116-1 to 116-10 each have similar hardware and perform their operation according to the similar software, so that the operation of one printing apparatus does not directly affect the operation of another. These printing apparatuses cooperate as a whole to print one page of image data.

In this example, the print timing defining signals (including the print start signal and position pulse) for the printing apparatuses are supplied from the medium conveying device 117. That is, the printing apparatuses print their print data in response to the instruction from the medium conveying device 117. This print start instruction may also be given from the host device 100 as long as it recognizes the print medium conveying state. In that case, the host device 100 may send the data to the printing apparatuses with required delays or add null data proportionate to the required delays to the data that it is going to send to the printing apparatuses.

1-7 Basic Operation of Image Forming System and its Effect (FIGS. 9 to 13)

FIG. 9 shows operation procedures performed by the information processing device 100, by the printing apparatuses 116 making up the printer complex system 400 and by the medium conveying device 117, and their mutual relationship.

To start a print operation, the information processing device 100 generates divided image data (image data divided in X and Y directions) (step S1001) and send them to the printing apparatuses. Each of the printing apparatuses 116, when it receives the data, uncaps the print heads and develops the data in the VRAM 801 (step S1041). When all the printing apparatuses 116-1 to 116-10 have completed the data reception, the information processing device 100 sends a medium conveying start command to the medium conveying device 117 (step S1002).

In response to this command, the medium conveying device 117 first drives the suction motor 908 (step S1061) to make preparations for attracting the print medium 206 to the upper surface of the media stage 202 by suction. Then it drives the conveying motor 205 to start conveying the print medium 206 (step S1062). When the front end of the print medium is detected (step S1063) and the print start position of the print medium reaches the associated printing apparatuses 116-1 to 116-10, the medium conveying device 117 starts sending the print start signals 914-1 to 914-4 and the continuous position pulse signal 913 (step S1064). As described above, the print start signal is output according to the distance from the medium sensor 911 to each printing apparatus.

When the print operation (step S1042) is completed in the printing apparatuses 116, they send a print end status to the information processing device 100 (step S1043) and end the operation. At this time, the print heads 801 are capped by the capping mechanism to prevent nozzles (ejection openings) from drying and clogging.

When the printing is complete and the print medium 206 is discharged from the media stage 202 (step S1065), the medium conveying device 117 sends a media conveying end status to the information processing device 100 (step S1066) and then stops the suction motor 908 and the conveying motor 205 (step S1067, S1068) before terminating the operation.

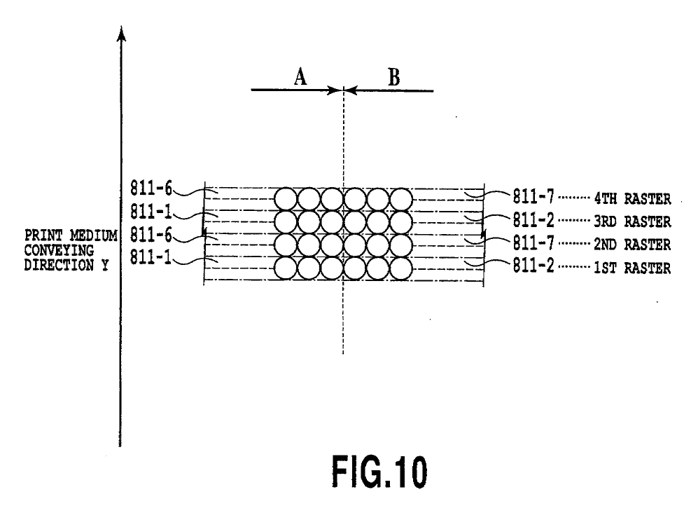

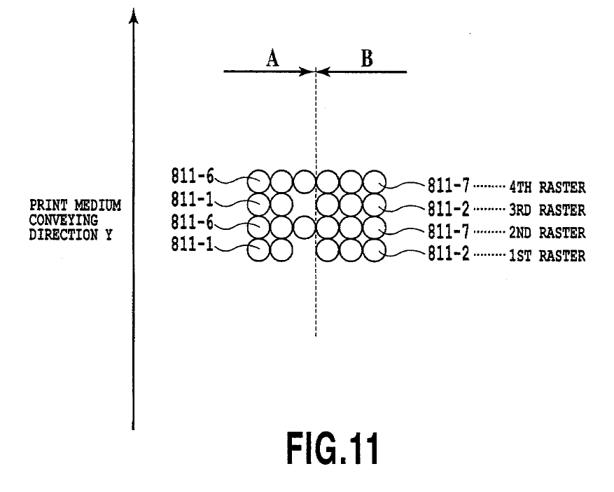

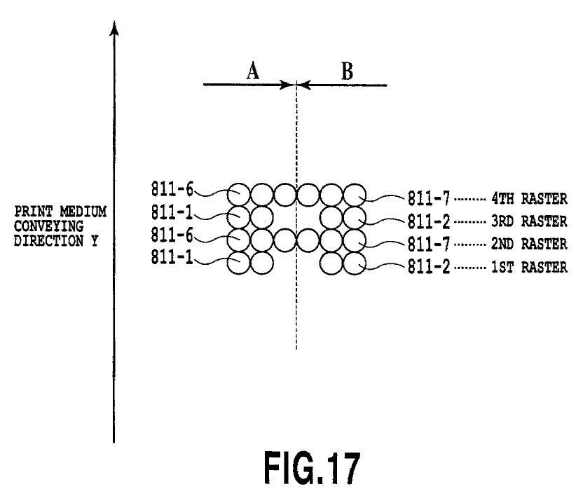

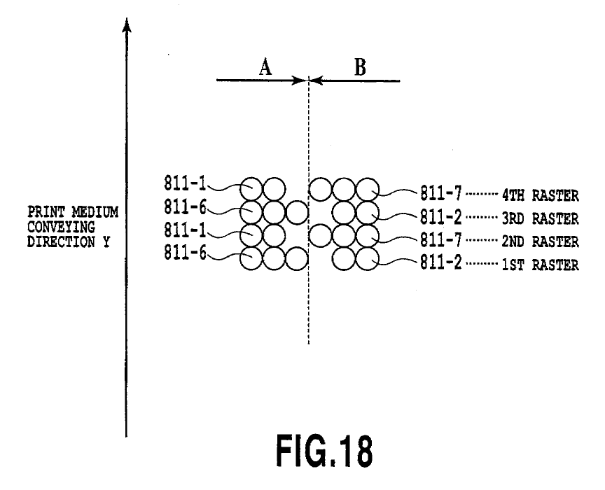

FIG. 10 is an enlarged schematic view of a printed image at a boundary portion between areas A and B of FIG. 2. What are denoted 811-1 and 811-6 and enclosed by a one-dot chain line are print heads installed in the printing apparatuses 116-1 and 116-6 participating in the printing of the area A. Circles inside the one-dot chain line represent nozzles arranged in the print heads or dots formed by them. Denoted 811-2 and 811-7 are print heads installed in printing apparatuses 116-2 and 116-7 participating in the printing of the area B. Circles inside represent nozzles arranged in these print heads or dots formed by them. This diagram only shows how the print heads are involved in the printing of an image but not physical positions of the print heads. This also applies to FIG. 11 to FIG. 13, FIG. 17 and FIG. 18 described later.

As shown in the figure, odd-numbered (1st and 3rd) rasters in the medium conveying direction Y are printed by the print heads 811-1 and 811-2 of the printing apparatuses 116-1 and 116-2 included in the upstream side printing apparatus group. Even-numbered (2nd and 4th) rasters are printed by the print heads 811-6 and 811-7 of the print heads 116-6 and 116-7 included in the downstream side printing apparatus group.

Let us consider a case where a nozzle at the right end of the print head 811-1 (facing the area B) fails to eject ink.

FIG. 11 is an enlarged schematic view of a printed image at a boundary portion between areas A and B when an ejection failure occurred. In an image forming system having only one printing apparatus group similar in arrangement to the upstream or downstream side printing apparatus group, if such an ejection failure occurs, a continuous linear region devoid of dots that extends in the Y direction is formed, degrading an image quality. In the system of this embodiment, however, since the printing apparatuses or print heads on the upstream side and those on the downstream side can be made to participate in the printing of alternate rasters, the adverse effects of ejection failure on the printed image can be alleviated.

This embodiment is not just effective in forming dots with a single color ink. It is also effective when forming secondary color dots using a plurality of color inks. This is because any ejection failure of a color ink may result in a change in the color of a dot of interest.

Not only is this embodiment effectively applicable to a case where an ejection failure occurs, but it is also effective in cases where small dots are formed by ink droplets of a smaller ink volume than is required.

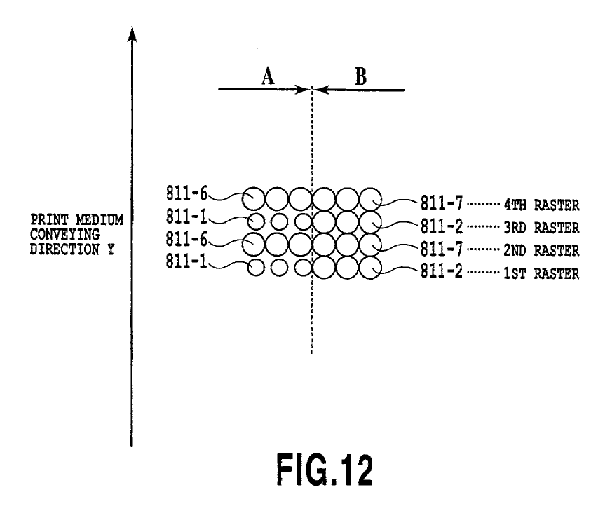

FIG. 12 is an enlarged schematic view of a printed image when an overall ink ejection volume of the print head 811-1 is small, thus forming small-diameter dots. Even in this case, the system of this embodiment can have the upstream side printing apparatuses or print heads and the downstream side printing apparatuses or print heads participate in the printing of alternate rasters, alleviating adverse effects of the reduced ink ejection volume on the image quality. It should be noted that this embodiment can be effectively applied to addressing not only the problem of small-diameter dots but also the problem of large-diameter dots formed by an ink ejection volume greater than a required one.

This invention is also effectively applicable where dots are formed at positions deviated from intended ones because of deflections of an ink ejection direction.

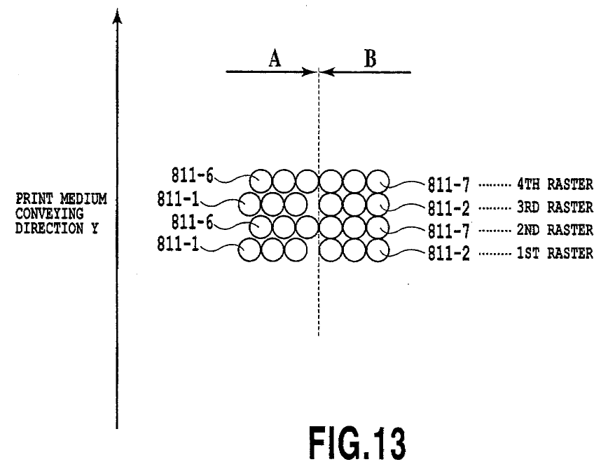

FIG. 13 is an enlarged schematic view of a printed image when dots formed by the print head 811-1 are deviated. Even in such a case, the system of this embodiment can have the upstream side printing apparatuses or print heads and the downstream side printing apparatuses or print heads participate in the printing of alternate rasters, thus alleviating the effects of such dot deviations on the image quality.

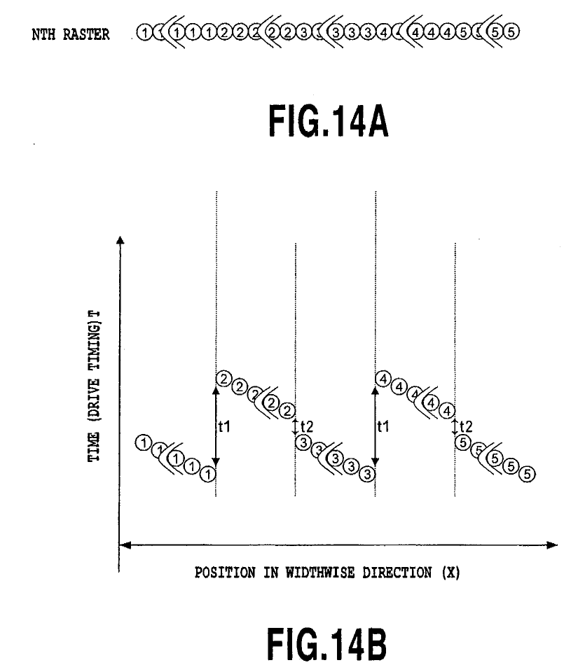

1-8 Modified Operation of Image Forming System and its Effects (FIG. 14 to FIG. 19)

As described above, the basic operation of this embodiment involves having the upstream side printing apparatuses or print heads and the downstream side printing apparatuses or print heads participate in the printing of alternate rasters (performing a 2-pass printing with the first setting). This produces a basic effect of being able to alleviate image quality degradations caused by ink ejection failures, ink ejection volume variations and dot forming position deviations, while at the same time increasing the printing speed, i.e., an advantage realized by placing the printing apparatuses of the printer complex system described in WO 2004/106068 in a parallel arrangement in the medium conveying direction. As long as this effect can be expected, the upstream side printing apparatuses or print heads and the downstream side printing apparatuses or print heads may be alternately brought into operation every two or more rasters or randomly, as well as every single rasters.

Not only can this embodiment produce the above basic advantage by using two printing apparatus groups of the same printing apparatus arrangement, it also can meet the user demands, such as reduced power consumption, faster printing speed and higher print quality, by performing modified operations such as described below.

In the above construction, the image forming (1-pass printing with the first setting) can be done using either the upstream or downstream side printing apparatus group. In this case, one of the upstream side and downstream side printing apparatus groups may be fixedly used according to the setting made on the screen of FIG. 4. Or the upstream and downstream printing apparatus groups may be alternately switched into operation every predetermined print volume (e.g., one page). In a 2-pass printing, electricity needs to be supplied at all times, not just during the actual ink ejection operation to print the assigned rasters. So, a 1-pass printing is more advantageous in terms of reducing power consumption. However, when performing a simple 1-pass printing, the following problem arises.

FIGS. 14A and 14B are explanatory diagrams showing positions of dots formed in one raster and nozzle drive timings to form these dots when the printing is done by using only the upstream printing apparatus group. Numbers “1” to “5” each enclosed in a circle represent dots formed by the nozzles of the print heads 811 of the printing apparatuses 116-1 to 116-5, respectively.

Each print head 811 has a large number of nozzles arrayed at high density and drives them not at once but sequentially on a time-division basis with a certain regularity in view of lowering of a capacity of power source. In the example shown, the nozzles of the print head are driven sequentially beginning with the right-end nozzle. So, the nozzle drive timings in each print head shift successively, with the right-end nozzle of the print head driven first and the left-end nozzle driven last, as shown in FIG. 14B.

In this example, as shown in FIG. 2, the printing apparatuses 116-1, 116-3 and 116-5 are located on the upstream side in the medium conveying direction Y while the printing apparatuses 116-2 and 116-4 are located on the downstream side in the Y direction. So, a time difference t2 from the drive timing for the left-end nozzle of the print head of the printing apparatus 116-3 to the drive timing for the right-end nozzle of the print head of the printing apparatus 116-2 is small (the same is true of the relation between the printing apparatus 116-5 and the printing apparatus 116-4). On the other hand, a time difference t1 from the drive timing for the right-end nozzle of the print head of the printing apparatus 116-1 to the drive timing for the left-end nozzle of the print head of the printing apparatus 116-2 is large (the same is true of the relation between the printing apparatus 116-3 and the printing apparatus 116-4). At boundary portions where the time difference between the drive timings or ink ejection timings is large, density unevenness is likely to occur.

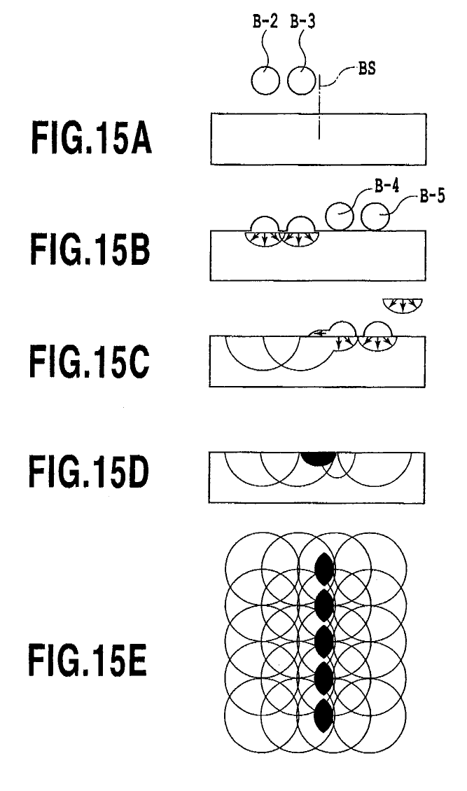

This phenomenon will be explained by referring to FIG. 15A to FIG. 15E. FIGS. 15A-D are schematic cross sections showing how adjoining dots are formed by ink droplets being ejected with time delays between them. FIG. 15E is a schematic plan view corresponding to FIG. 15D.

First, FIG. 15A shows a state immediately before ink droplets B-2 and B-3 ejected from two nozzles on one side of a boundary BS land on a print medium. FIG. 15B shows a state in which these ink droplets that have just landed are spreading in a planar direction (horizontally) and penetrating into the print medium and immediately before ink droplets B-4 and B-5 ejected from two nozzles on the other side of the boundary BS land on the print medium.

FIG. 15C shows a state in which the ink droplets that have landed first are at a last stage of penetration process, with the secondly landed ink droplets beginning to penetrate into the print medium. In this state, the secondly landed ink droplet B-4 is blocked from penetrating in a depth direction by the firstly landed ink droplet B-3 that has already penetrated and spread horizontally, with the result that the secondly landed ink droplet begins spreading horizontally.

FIGS. 15D and 15E are a schematic cross-sectional view and a schematic plan view showing a state in which the secondly landed ink droplets having completed their penetration process. In this state the dot of ink droplet B-4 is blocked from penetrating in the depth direction and forced to spread horizontally. Such a spreading of dot increases the local density of ink or colorant on the print medium, resulting in an increase in a density level of the image at the boundary BS. Should such a portion with an elevated density level be formed successively in the medium conveying direction (a vertical direction in FIG. 15E), a stripe-like density unevenness appears. This problem becomes pronounced as the time difference between the formations of adjoining dots increases because the penetration and horizontal spreading of the firstly landed ink droplets have progressed to a greater extent.

As shown in FIG. 14, when a 1-pass printing is performed, if only one of the upstream and downstream printing apparatus groups is used, there are two boundary portions where the time difference between the formations of left and right dots is large, i.e., where the density levels are high.

To deal with this problem, this embodiment employs a modified operation that makes a second setting which selects appropriate printing apparatuses from the upstream and downstream side printing apparatus groups to make the boundary portions with elevated density levels as nonexistent as possible.

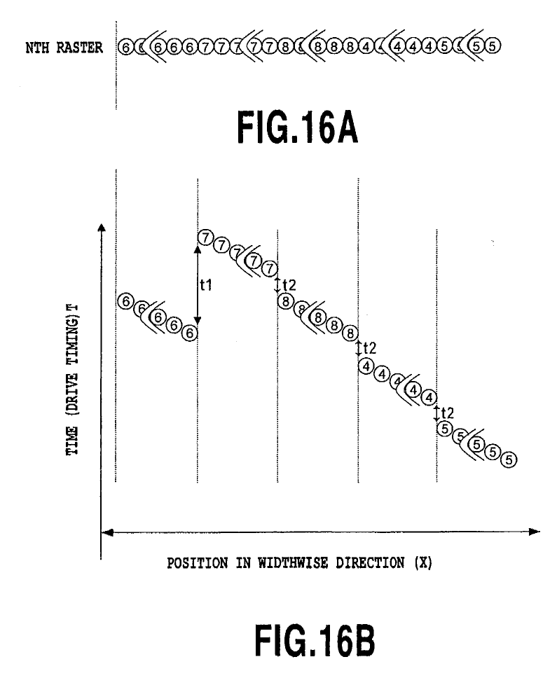

FIG. 16A and FIG. 16B are explanatory diagrams showing positions of dots in one raster and nozzle drive timings to form these dots when the modified operation is applied. Numerals “6”, “7”, “8”, “4” and “5” each enclosed in a circle represent dots formed by nozzles in the print heads 811 of the printing apparatuses 116-6, 116-7, 116-8, 116-4 and 116-5, respectively. In this example, during the 1-pass printing, the printing apparatuses 116-4 and 116-5 are chosen from the upstream side printing apparatus group and the printing apparatuses 116-6 to 116-8 from the downstream side printing apparatus group. The nozzle drive conditions are the same as in FIG. 14.

In this example, the printing apparatus 116-5, printing apparatus 116-4, printing apparatuses 116-6 and 116-8, and printing apparatus 116-7 are arranged at equal pitches p (see FIG. 2). So, the following three time differences the time difference from the drive timing of the left-end nozzle of the print head of the printing apparatus 116-5 to the drive timing of right-end nozzle of the printing apparatus 116-4, the time difference from the drive timing of the left-end nozzle of the print head of the printing apparatus 116-4 to the drive timing of the right-end nozzle of the printing apparatus 116-8, and the time difference from the drive timing of left-end nozzle of the print head of the printing apparatus 116-8 to the drive timing of the right-end nozzle of the printing apparatus 116-7—are all small, equal to t2. The only time when a relatively large time difference t1 occurs is from the drive timing of the right-end nozzle of the print head of the printing apparatus 116-6 to the drive timing of left-end nozzle of the print head of the printing apparatus 116-7.

Therefore, even when an image is formed over the entire print areas A to E, there is only one boundary portion where the relatively large time difference t1 occurs, preventing image quality degradations more effectively than in the case of FIG. 14. Further, when an image is formed over four or three areas, for example, the boundary portion where the relatively large time difference occurs can be eliminated by selecting and using the printing apparatuses 116-5, 116-4, 116-8 and 116-7 or printing apparatuses 116-5, 116-4 and 116-8.

The effect of this modified operation depends on the arrangement pitches in the medium conveying direction of the printing apparatuses. The arrangement pitches need only be determined so as to satisfy the time difference relation of t2<t1. If all the arrangement pitches are set equal as with this example, the desired effect will surely be produced.

The selection of printing apparatuses described above may be set to be automatically executed when a 1-pass printing is chosen. Alternatively, the above printing apparatus selection may be performed for each print area by clicking on an “option” field 305 in FIG. 4,

In response to the above selection made, the procedure of FIG. 5 executes processing to generate divided image data for the associated printing apparatuses or print heads to print.

Such a change of the combination of printing apparatuses participating in the 1-raster printing, i.e., the second setting, can also be applied to the 2-pass printing.

As described above with reference to FIG. 11, the basic operation of this embodiment can alleviate adverse effects on the image quality even if a right-end nozzle of the print head 811 included in the printing apparatus 116-1 (a nozzle facing the area B), for example, should fail to eject. However, if such an ejection failure occurs also with a left-end nozzle of the print head 811-2 included in the printing apparatus 116-2, two dots fail to be printed at the boundary portion as shown in FIG. 17, showing up the print quality degradations.

In such a case, the image quality degradations can be made less noticeable by changing the combination of printing apparatuses cooperating in the raster printing, i.e., by changing the print head combination so as to pair the print heads 811-1 and 811-7 of the printing apparatuses 116-1 and 116-7 and to pair the print heads 811-2 and 811-6 of the printing apparatuses 116-2 and 116-6, as shown in FIG. 18. This approach can also be effectively applied to such problems as the ejection volume variations shown in FIG. 12 and the dot position deviations shown in FIG. 13.

The change of the combination of printing apparatuses can be performed, for example, by clicking on the “option” field 305 in FIG. 4.

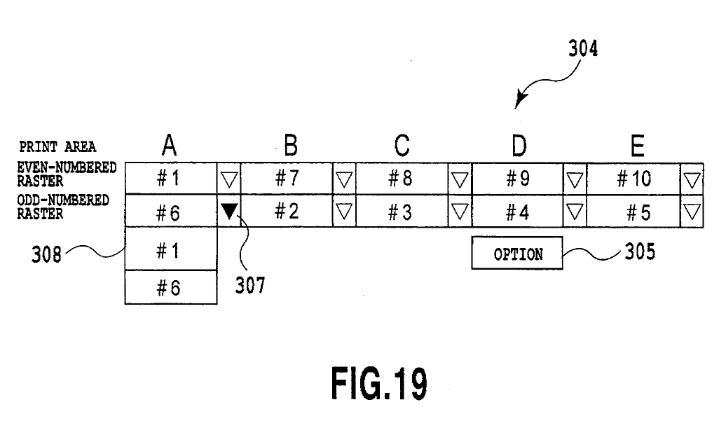

FIG. 19 shows an example setting in the assignment setting field 304 invoked by the above clicking action. For each of the printing apparatuses (#1 to #10) a button 307 is clicked to display a pull-down menu to change the printing assignment of odd-numbered rasters and even-numbered rasters to desired printing apparatuses. Then, in response to this change, the procedure in FIG. 5 executes processing to generate divided image data for the assigned printing apparatuses or print heads to print.

As described above, not only can this embodiment produce advantageous effects of the basic operation with the upstream and downstream printing apparatus groups arranged as shown in FIG. 2, it can also allow the user to select the printing apparatuses or print heads for raster printing and thereby flexibly allocate image data to the printing apparatuses or print head in the arrangement as shown in FIG. 2. The system of this embodiment therefore is capable of minimizing adverse effects of image quality degradations that would otherwise occur in various conditions.

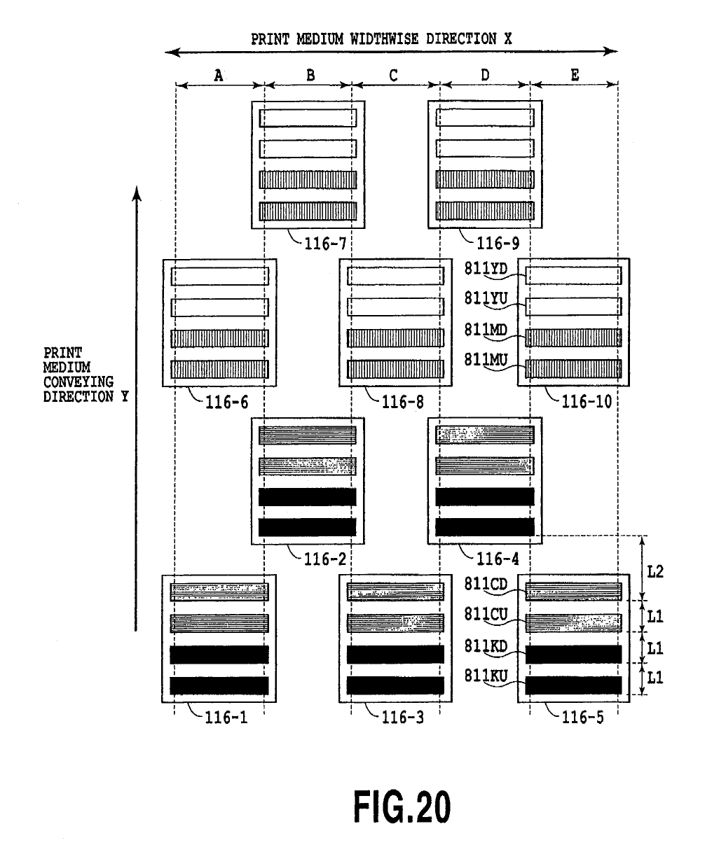

### Second Embodiment (FIG. 20 to FIG. 22)

FIG. 20 is a schematic top view of the printer complex system in the image forming system according to a second embodiment. Its basic system configuration is similar to the first embodiment but the second embodiment differs from the first embodiment in the print heads installed in the printing apparatuses 116-1 to 116-10.

More specifically, in the first embodiment, each of the printing apparatuses is provided with four print heads 811Y, 811M, 811C and 811K to eject yellow (Y), magenta (M), cyan (C) and black (K) inks. In other words, all the printing apparatuses have the same construction made up of four different print heads. In the second embodiment, however, there are two different groups of printing apparatuses. The printing apparatuses of the first group are each provided with two print heads 811KU, 811KD for ejecting K ink and two print heads 811CU, 811CD for ejecting C ink. The printing apparatuses of the second group are each provided with two print heads 811MU, 811ND for ejecting M ink and two print heads 811YU, 811YD for ejecting Y ink. The first printing apparatus group installed on an upstream side has the same number of printing apparatuses as in the first embodiment, or five printing apparatuses, put in a staggered arrangement, while the second printing apparatus group installed on a downstream side has five printing apparatuses in a staggered arrangement. Over the entire print areas A-E, the print heads 811KU, 811KD, 811CU, 811CD, 811MU, 811MD, 811YU, 811YD are arranged in this order from the upstream side of the medium conveying direction. So, the orders of color overlapping are also equal in all the print areas.

In each printing apparatus, it is assumed that the print heads are arranged at equal pitches (L1). In any one printing apparatus and another printing apparatus immediately downstream of the first, it is also assumed that the pitches in the medium conveying direction (L2) between the most downstream print head of the first printing apparatus and the most upstream print head of the second printing apparatus are equal.

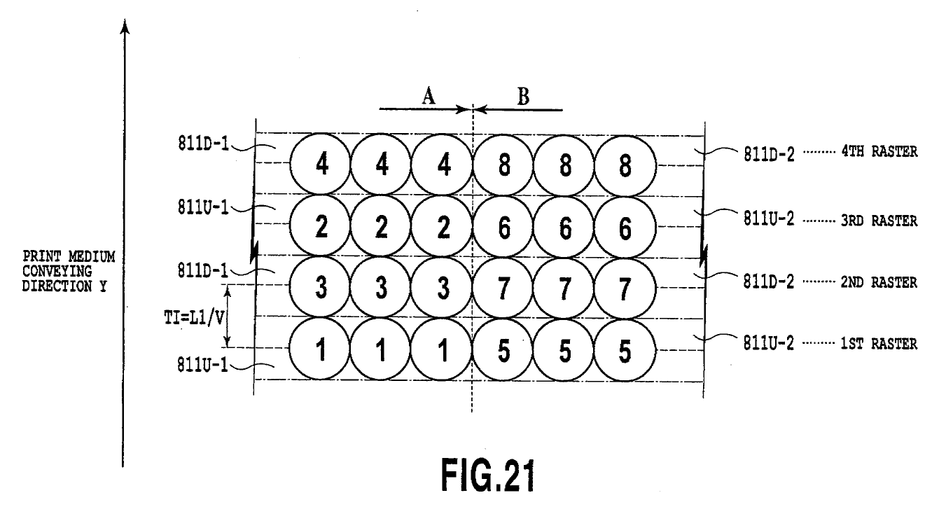

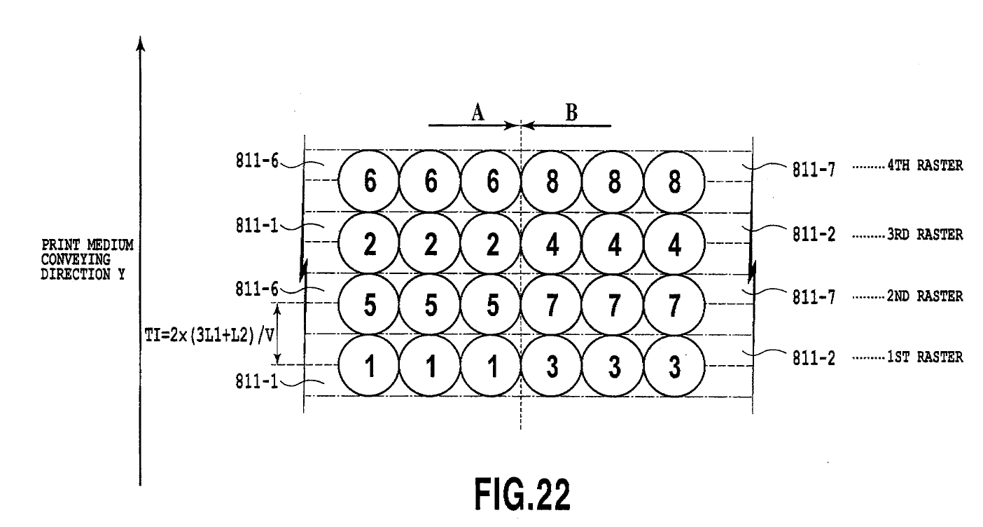

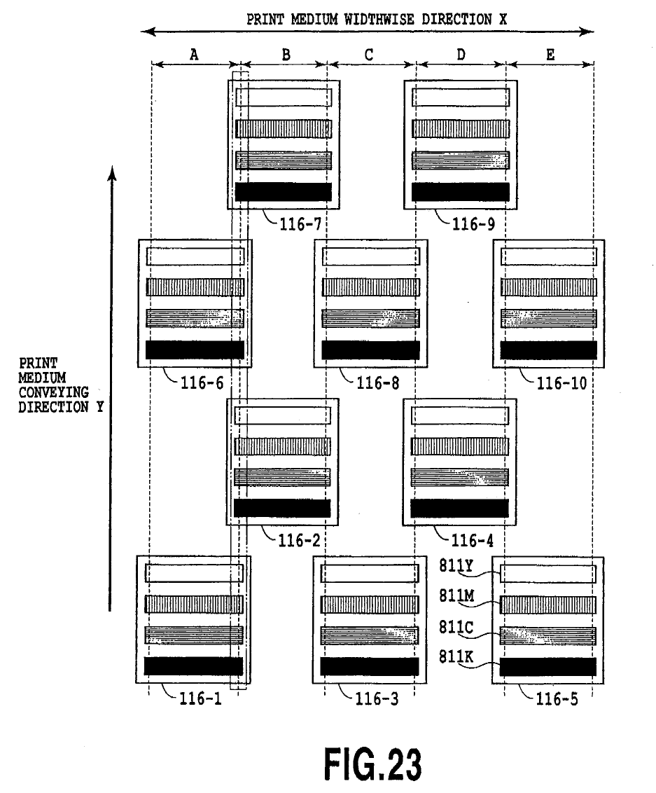

FIG. 21 is an enlarged schematic diagram showing an image formed at a boundary portion between the print areas A and B of FIG. 20 by the image forming system of this embodiment. Here, reference numerals 811U-1 and 811D-1 enclosed by one-dot chain line represent print heads on the upstream and downstream side (e.g., print heads for K ink), respectively, in the printing apparatus 116-1 assigned to print the area A, with circles inside the chain lines indicating dots formed by the nozzles of these print heads. Denoted 811U-2 and 811D-2 are print heads situated upstream and downstream (e.g., print heads for K ink), respectively, in the printing apparatus 116-2 assigned to print the area B, with circles inside the chain lines representing dots formed by the nozzles of these print heads. Numbers in the circles indicate the order in which the dots are formed. It is noted that this figure explains how the individual print heads are involved in the printing of an image but does not show physical positions of the print heads. This also applies to FIG. 22 and FIG. 23 described later.

As shown in this figurer odd-numbered (1st and 3rd) rasters in the medium conveying direction Y are printed by print heads 811U-1 and 811U-2 on the upstream side of the printing apparatuses 116-1 and 116-2. Even-numbered (2nd and 4th) rasters are printed by print heads 811D-1 and 811D-2 on the downstream side of the printing apparatuses 116-1 and 116-2.

As shown in FIG. 15, if, when adjoining dots are formed, a difference in droplet landing time between them is large, density unevenness occurs at a boundary portion of the print areas. Although FIG. 15 explains this phenomenon in the medium width direction (X direction), the similar phenomenon also occurs in the medium conveying direction (Y direction).

In FIG. 21, let us consider a relation between adjoining rasters in each print area, e.g., a relation between a dot printed first by the upstream print head 811U-1 and a dot printed third by the downstream print head 811D-1. If we let an arrangement pitch of print heads in the printing apparatus be L1 and a medium conveying velocity be V, a dot formation time difference between them is given by T1=L1/V. A time difference between the instant when the print head 811U-1 has formed its first dot and the instant when the print head 811U-2 forms its first dot is T2=(3×L1+L2)/V.

FIG. 22 is an enlarged schematic diagram showing an image formed at a boundary portion between the print areas A and B of FIG. 2 by the image forming system of the first embodiment. Here, reference numerals 811-1 and 811-6 enclosed by one-dot chain line represent print heads (e.g., print heads for K ink) in the printing apparatus 116-1 (upstream side) and 116-6 (downstream side) assigned to print the area A, with circles inside the chain lines representing dots formed by these print heads. Reference numerals 811-2 and 811-7 represent print heads (e.g., print heads for K ink) in the printing apparatuses 116-2 (upstream side) and 116-7 (downstream side) assigned to print the area B. Circles inside the chain lines represent dots formed by these print heads. The dots are formed in the order of numbers shown in the circles.

In the first embodiment, let us consider a relation between adjoining rasters in each print area, e.g., a relation between a dot printed first by the print head 811-1 of the upstream printing apparatus 116-1 and a dot printed fifth by the print head 811-6 of the downstream printing apparatus 116-6. In the case of the first embodiment, the print head 811-1 and the print head 811-6 are at a distance of 2×(3×L1+L2) So, a dot formation time difference between the two dots is given by T1=2×(3×L1+L2)/V. A time difference between the instant when the print head 811-1 has formed its first dot and the instant when the print head 811-2 forms its first dot is T2=(3×L1+L2)/V as similar to the second embodiment.

As can be seen from the comparison between the first and second embodiment, the dot formation time difference between the adjoining rasters is smaller in the second embodiment. Thus, in addition to offering the basic advantage similar to that of the first embodiment, the second embodiment can also reduce density unevenness occurring in the medium conveying direction.

When performing a 1-pass printing (that uses only the upstream print head 811U or downstream print head 811D for the same color ink) the modified operation based on the second setting, which appropriately selects desired print heads for use in each print area, can be performed. For example, for the printing of areas A, C and E, the downstream print head 811D may be used; and for the areas B and D the upstream print head 811U may be used. This reduces the dot formation time difference between the adjoining areas.

Further, when performing a 2-pass printing (that uses both the upstream print head 811U and the downstream print head 811D for the same color ink) the modified operation based on the second setting, which changes a combination of print heads cooperating in the raster printing, can be executed. For example, in a relation between the printing apparatuses 116-1 and 116-2, the print head combinations can be changed so as to pair the print heads 811D-1 and 811U-2 and to pair the print heads 811U-1 and 811D-2.

It is also possible to employ in this embodiment an arrangement which, as in a third embodiment described next, arrays print heads so that their end portions overlap in the medium conveying direction (Y direction).

### Third Embodiment (FIG. 23 to FIG. 26)

In the first and second embodiment, described is an arrangement in which the printing apparatuses 116-1 to 116-5 and 116-6 to 116-10 are each assigned to print the areas that do not overlap in the Y direction. In the third embodiment, an arrangement in which printing apparatuses covering adjoining print areas are arranged to overlap each other will be explained.

FIG. 23 is a schematic plan view of a printer complex system of an image forming system according to the third embodiment of this invention. While its basic system configuration is similar to that of the first embodiment, the third embodiment differs from the first embodiment in that the printing apparatuses 116-1 to 116-10 are arranged so that end portions of the print heads 811 overlap near a boundary portion between adjoining print areas in the medium conveying direction (Y direction).

This overlapping arrangement is used to prevent portions between adjoining print areas from being left unprinted or blank due to degraded arrangement precision of the printing apparatuses 116-1 to 116-5 and 116-6 to 116-10. More precisely, print heads (116-1, 116-6) assigned to the printing of area A and print heads (116-2, 116-7) assigned to the printing of area B, for example, are arranged to extend into each other's area by a few nozzles. In their overlapping region a boundary portion between the adjoining areas is set. Nozzles beyond the boundary portion are not used in the printing operation.

To implement this, for example, the information processing device 100 may generate divided image data for a usable nozzle range in each color print head of individual printing apparatuses, add null data to the out-of-use nozzles and supply necessary data to the associated printing apparatuses. Alternatively, the information processing device may generate and send divided image data for the usable nozzle range in each color print head of individual printing apparatuses and also send setting data for the usable nozzle range to the individual printing apparatuses so that the printing apparatuses, according to the setting data, can cause only the usable nozzle range to perform ink ejection based on the divided image data. Or, the information processing device 100 may generate and send divided image data for the nozzle array range including out-of-use nozzles in each color print head of each printing apparatus and also send setting data for the usable nozzle range to the individual printing apparatuses so that the printing apparatuses, according to the setting data, can extract the image data corresponding to the usable nozzle range and cause only the usable nozzle range to perform ink ejection based on the extracted image data.

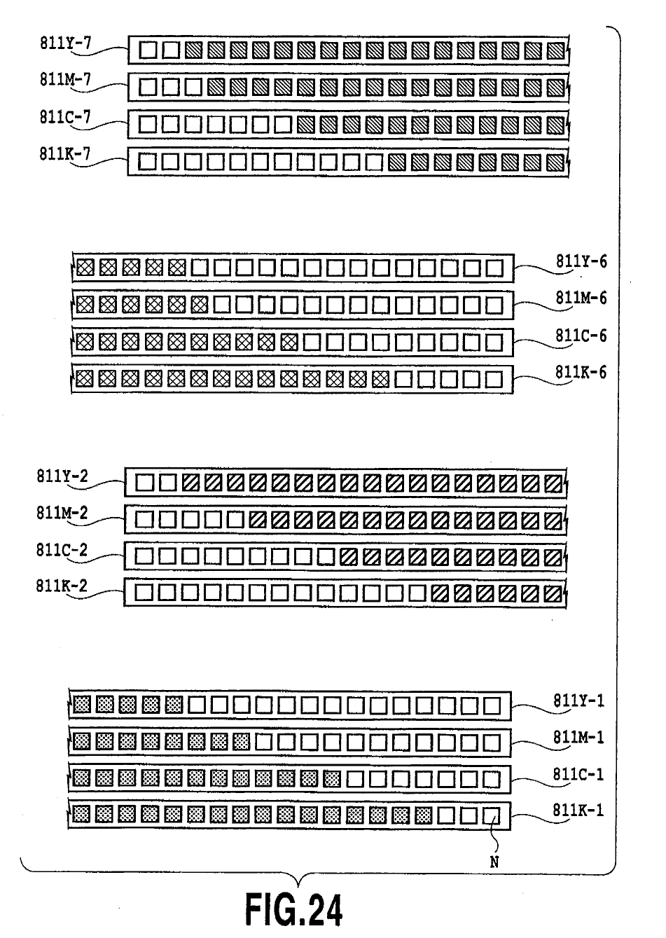

FIG. 24 is an enlarged schematic view of a portion BP of FIG. 23, explaining an overlapping arrangement of printing apparatuses in this embodiment. As shown in this figure, the print heads of the printing apparatus 116-1 and the printing apparatus 116-2 are arranged to overlap with each other by 16 nozzles; and the print heads of the printing apparatus 116-6 and the printing apparatus 116-2 are also arranged to overlap by 16 nozzles. Denoted N are nozzles arrayed in the print heads. Nozzles shown in blank are out-of-use nozzles and those shown hatched are in-use nozzles. In the print heads of the same color ink, a gap between the rightmost in-use nozzle in the print head 811K-1 of the printing apparatus 116-1 and the leftmost in-use nozzle of the print head 811K-2 of the printing apparatus 116-2 forms a boundary. In this embodiment, different boundaries are set for different ink colors, as shown in this figure. At the same time, even in the print heads of the same color ink, the boundary is differentiated between the print heads included in the upstream side printing apparatuses and the print heads included in the downstream side printing apparatuses.

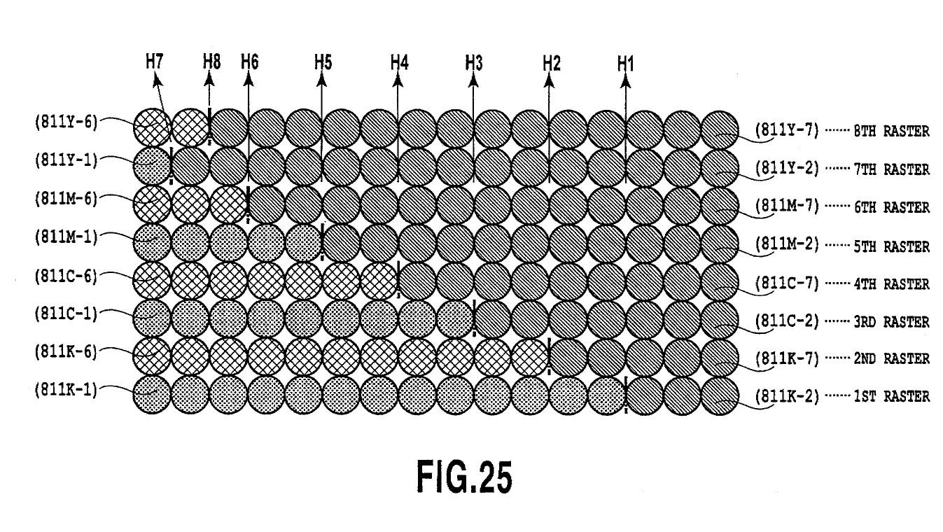

FIG. 25 is one example of image formed by the print heads arranged as shown in FIG. 24, with odd-numbered rasters formed by the print heads included in the upstream side printing apparatuses and with even-numbered rasters formed by the print heads included in the downstream side printing apparatuses. The first and second rasters are made up of K ink dots in a continuous row; the third and fourth rasters are made up of C ink dots in a continuous row; the fifth and sixth rasters are made up of M ink dots in a continuous row; and seventh and eighth rasters are made up of Y ink dots in a continuous row.

H1 represents a boundary between the rightmost in-use nozzle of the print head 811K-1 and the leftmost in-use nozzle of the print head 811K-2; H2 represents a boundary between the rightmost in-use nozzle of the print head 811K-6 and the leftmost in-use nozzle of the print head 811K-7; similarly, H3 and H4 represent boundaries between the rightmost in-uses nozzles of the print heads 811C-1 and 811C-6 and the leftmost in-use nozzles of the print head 811C-2 and 811C-7, respectively; H5 and H6 represent boundaries between the rightmost in-use nozzles of the print heads 811M-1 and 811M-6 and the leftmost in-use nozzles of the print heads 811M-2 and 811M-7, respectively; and H7 and H8 represent boundaries between the rightmost in-use nozzles of the print heads 811Y-1 and 811Y-6 and the leftmost in-use nozzles of the print heads 811Y-2 and 811Y-7, respectively.

As described above with reference to FIG. 15, since there is a dot formation timing difference between the dot to the left of the boundary and the dot to the right of the boundary, density unevenness is likely to occur at the boundary portion. If a fixed boundary is applied for all colors, density unevenness caused by the time difference show as a line or stripe extending along the fixed boundary in the medium conveying direction.

This embodiment, however, sets different boundaries for different ink colors and, even in the print heads of the same color ink, differentiates the boundary between the print heads included in the upstream printing apparatuses and the print heads included in the downstream printing apparatuses. Therefore, the positions of boundaries (H1 to H8) are not aligned in the medium conveying direction but scattered in the medium width direction, alleviating the stripe-like density unevenness.

while FIG. 25 represents a case in which dots of primary colors K, C, M or Y are formed in each raster, the scattering of the boundaries can also be similarly applied where dots of secondary colors R, G, B are formed by color mixing. In this case, too, the stripe-like density unevenness can be made less noticeable.

In this embodiment also, when a 1-pass printing is performed, a modified operation based on the second setting to appropriately select desired printing apparatuses in each print area can be performed, as in the first embodiment.

Further, when performing a 2-pass printing, a modified operation based on the second setting of changing the combination of printing apparatuses cooperating in the raster printing can also be performed. In that case, the boundary setting described above can also be done to prevent overlapping of the in-use nozzles or of the out-of-use nozzles in the relation between the print heads 811K-1 and 811K-2 and between the print heads 811K-6 and 811K-7, for example. In this embodiment, since the print heads are so arranged that their ends overlap in the conveying direction (Y direction) near a boundary between adjoining areas, any ejection failures such as shown in FIG. 11 or FIG. 17, should they occur, can be dealt with by appropriately changing the in-use/out-of-use setting of the nozzles. However, it is desirable to make the print head combination changeable in order to be able to cope with a situation where the print heads that are to be paired (e.g., print heads 811K-1 and 811K-2) may have ejection volume variations, such as shown in FIG. 12.

Further, while the third embodiment has been described to set at 16 nozzles the overlapping range of the printing apparatuses or print heads assigned to print the adjoining areas, the overlapping range can be determined as required and may not be uniformed. As long as the purpose of making the stripe-like density unevenness less noticeable is achievable, the way of scattering the boundaries is not limited to the one shown in FIG. 25. For example, the boundaries may partly overlap.

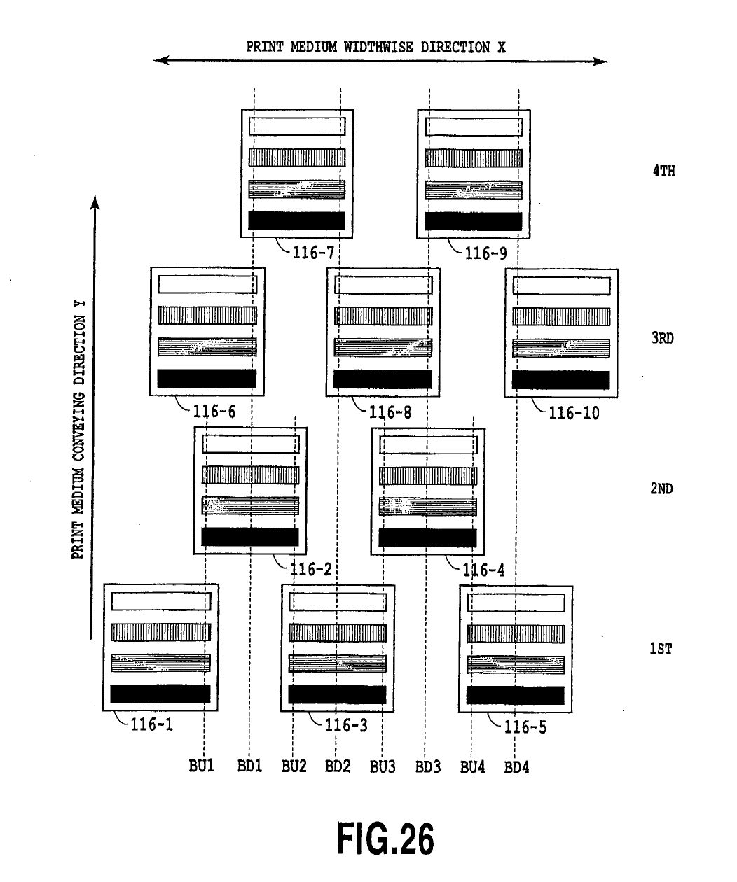

Further, as shown in FIG. 26, the upstream printing apparatus group and the downstream printing apparatus group may be shifted widthwise of the print medium. Here, BU1, BU2, BU3 and BU4 roughly represent overlapping ranges between printing apparatuses 116-1 and 116-2, between printing apparatuses 116-2 and 116-3, between printing apparatuses 116-3 and 116-4 and between printing apparatuses 116-4 and 116-5, respectively. BD1, BD2, BD3 and BD4 roughly represent overlapping ranges between printing apparatuses 116-6 and 116-7, between printing apparatuses 116-7 and 116-8, between printing apparatuses 116-8 and 116-9 and between printing apparatuses 116-9 and 116-10, respectively.

In the arrangement of FIG. 26, the overlapping ranges between the printing apparatuses in the upstream printing apparatus group (e.g., BU1) and the overlapping ranges between the printing apparatuses in the downstream printing apparatus group (e.g., BD1) are not aligned. This can further scatter the boundaries when compared with the arrangement of FIG. 23, making the stripe-like density unevenness even more difficult to recognize visually.

It should be noted that although the arrangement of FIG. 26 does not allow the combination of printing apparatuses or print heads cooperating in the raster printing to be changed during a 2-pass printing, the combination can be changed during a 1-pass printing using the printing apparatuses 116-6, 116-7, 116-8, 116-4 and 116-5.

### Others

The present invention is not limited to the above embodiments but various modifications may be made.

For example, the combination of print heads cooperating in the raster printing may be made changeable for each color. Also for color tone (including color and density), any suitable number of types thereof may be used as required.

Further, although in the above embodiments, an example case has been described in which five printing apparatuses are arranged staggered in each of the upstream and downstream printing apparatus groups, the number of printing apparatuses can be determined as required. The number of printing apparatus groups can also be determined as required. For example, the printing apparatus groups may be arranged, one each in an upstream, a midstream and a downstream position.

Furthermore, when processing is carried out by the information processing device including a computer, the processing is realized by a control program such as an application software or printer driver. That is, the processing is realized such that program codes of the application software or printer driver are supplied to a system or apparatus and executed by the computer (or CPU or MPU) of the system or apparatus.

In this case, the program codes themselves provide a novel feature of the invention. Accordingly, the program codes themselves and a unit for supplying the program codes to the computer by means of communication or a storage medium so as to activate the computer based on the program codes stored therein are also included in the scope of the invention. As the storage medium for supplying the program codes, for example, a hard disk, an optical disk, a magneto-optical disk, a CD-R, a DVD, a magnetic tape, a non-volatile memory card, or a ROM may be used as well as a flexible disk or a CD-ROM.

In addition, the function of the foregoing embodiments can be realized not only in the case where the computer executes retrieved program code, but also in the case where an OS operated in the computer carried out a part or all of an actual processing on the basis of the command from the program code. Such a system is also encompassed within the scope of the present invention.

Furthermore, the function of the foregoing embodiments can be realized by using a system in which the retrieved program codes are written on a memory provided in a function expanding board inserted into the computer or a memory provided in a function expanding unit connected to the computer, and then a part of or all of processes are executed by the CPU or the like provided in the function expanding board or the function expanding unit on the basis of the command from the program code. Such a system is also encompassed within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-284102, filed Oct. 31, 2007, which is hereby incorporated by reference herein in its entirety.

What is claimed is:

1. An image forming system having a printing apparatus group consisting of a plurality of printing apparatuses, wherein the printing apparatuses have print heads, each provided with nozzles arrayed in a predetermined direction, wherein the printing apparatuses are arranged spread in the predetermined direction and in a print medium conveying direction to cooperate with one another to print rasters extending in the predetermined direction, the image forming system comprising:
at least two of the printing apparatus groups arranged in the print medium conveying direction; and
an information processing device to generate divided image data by dividing image data into pieces corresponding to positions in the predetermined direction and the print medium conveying direction of the printing apparatuses in the at least two printing apparatus groups and to transfer the generated divided image data to the associated printing apparatuses;
wherein the information processing device can make a first setting and a second setting;
wherein the first setting is used to generate the divided image data to cause the plurality of printing apparatuses included in the same printing apparatus group to cooperate with each other in printing the same raster; and
wherein the second setting is used to generate the divided image data to cause the printing apparatuses included in one of the printing apparatus groups to cooperate with the printing apparatuses included in another printing apparatus group in printing the same raster, the other printing apparatus group differing in position in the predetermined direction from the first group.

2. An image forming system as claimed in claim 1, wherein in each of the printing apparatuses the print heads are provided in numbers corresponding to a plurality of color tones.

3. An image forming system as claimed in claim 1, wherein in each of the printing apparatus groups the plurality of printing apparatuses are arranged so that their print head end portions overlap with each other in the medium conveying direction;
wherein in a range of the overlapping, a boundary is set to divide an image in the predetermined direction;
wherein those of the arrayed nozzles outside the boundary are set in an out-of-use state; and
wherein according to the first and second setting, the boundary is set between the printing apparatuses cooperating with each other in the raster printing.

4. An image forming system as claimed in claim 3, wherein in each of the printing apparatuses the print heads are provided in numbers corresponding to a plurality of color tones; and
wherein different boundaries are set for different color tones.

5. An image forming system using a plurality of printing apparatuses, wherein the printing apparatuses are arranged spread in a predetermined direction and in a print medium conveying direction to cooperate with one another to print rasters extending in the predetermined direction, wherein each of the printing apparatuses is provided with at least two print heads corresponding to the same color tone, the print head having nozzles arrayed in the predetermined direction, the image forming system comprising;
an information processing device to generate divided image data by diving image data into pieces corresponding to positions of the printing apparatuses in the predetermined direction and to positions in the print medium conveying direction of the at least two print heads and to transfer the generated divided image data to the associated printing apparatuses;
wherein the information processing device can make a first setting and a second setting;
wherein the first setting is used to generate the divided image data to cause those print heads in the plurality of printing apparatuses that are located at matching positions in the medium conveying direction to cooperate with each other in printing the same raster; and
wherein the second setting is used to generate the divided image data to cause those print heads in the plurality of printing apparatuses that are located at unmatching positions in the medium conveying direction to cooperate with each other in printing the same raster.

6. An information processing device to be employed in an image forming system as claimed in claim 1, to generate divided image data by dividing image data into pieces corresponding to positions in the predetermined direction and the print medium conveying direction of the printing apparatuses in the at least two printing apparatus groups and to transfer the generated divided image data to the associated printing apparatuses;
wherein the information processing device can make a first setting and a second setting;
wherein the first setting is used to generate the divided image data to cause the plurality of printing apparatuses included in the same printing apparatus group to cooperate with each other in printing the same raster; and
wherein the second setting is used to generate the divided image data to cause the printing apparatuses included in one of the printing apparatus groups to cooperate with the printing apparatuses included in another printing apparatus group in printing the same raster, the other printing apparatus group differing in position in the predetermined direction from the first group.

7. An information processing device to be employed in an image forming system as claimed in claim 5, to generate divided image data by diving image data into pieces corresponding to positions of the printing apparatuses in the predetermined direction and to positions in the print medium conveying direction of the at least two print heads and to transfer the generated divided image data to the associated printing apparatuses;
wherein the information processing device can make a first setting and a second setting;
wherein the first setting is used to generate the divided image data to cause those print heads in the plurality of printing apparatuses that are located at matching positions in the medium conveying direction to cooperate with each other in printing the same raster; and
wherein the second setting is used to generate the divided image data to cause those print heads in the plurality of printing apparatuses that are located at unmatching positions in the medium conveying direction to cooperate with each other in printing the same raster.

8. A method of information processing to be employed in an image forming system as claimed in claim 1, to generate divided image data by dividing image data into pieces corresponding to positions in the predetermined direction and the print medium conveying direction of the printing apparatuses in the at least two printing apparatus groups and to transfer the generated divided image data to the associated printing apparatuses;
wherein the method can make a first setting and a second setting;
wherein the first setting is used to generate the divided image data to cause the plurality of printing apparatuses included in the same printing apparatus group to cooperate with each other in printing the same raster; and
wherein the second setting is used to generate the divided image data to cause the printing apparatuses included in one of the printing apparatus groups to cooperate with the printing apparatuses included in another printing apparatus group in printing the same raster, the other printing apparatus group differing in position in the predetermined direction from the first group.

9. A method of information processing to be employed in an image forming system as claimed in claim 5, to generate divided image data by diving image data into pieces corresponding to positions of the printing apparatuses in the predetermined direction and to positions in the print medium conveying direction of the at least two print heads and to transfer the generated divided image data to the associated printing apparatuses;
wherein the method can make a first setting and a second setting;
wherein the first setting is used to generate the divided image data to cause those print heads in the plurality of printing apparatuses that are located at matching positions in the medium conveying direction to cooperate with each other in printing the same raster; and
wherein the second setting is used to generate the divided image data to cause those print heads in the plurality of printing apparatuses that are located at unmatching positions in the medium conveying direction to cooperate with each other in printing the same raster.

10. A control program for making a computer execute a method of information processing as claimed in claim 8.

11. A storage medium storing a control program for making a computer execute a method of information processing as claimed in claim 8.

12. A control program for making a computer execute a method of information processing as claimed in claim 9.

13. A storage medium storing a control program for making a computer execute a method of information processing as claimed in claim 9.
